(19) United States
(12) Patent Application Publication
(10) Pub. No.: US 2005/0228853 A1
(43) Pub. Date: Oct. 13, 2005

(54) Method and system for supporting service provision

(76) Inventors: Shinya Yamamura, Yokohama (JP); Yoshiharu Sato, Yokohama (JP); Katsunori Iwamoto, Yokohama (JP)

Correspondence Address: KATTEN MUCHIN ROSENMAN LLP, 575 MADISON AVENUE, NEW YORK, NY, 10022-2585, US

(21) Appl. No.: 10/953,814

(22) Filed: Sep. 29, 2004

(30) Foreign Application Priority Data
Mar. 23, 2004 (JP) 2004-085530

(51) Int. Cl. G06F 15/16

(52) U.S. Cl. 709/200

(57) ABSTRACT

A group management server receives, from a device joining an ad hoc group related to the provision of a service as a member thereof, a member registration request including communication information inclusive of a method for communication with the device becoming the member and registers the device in the ad hoc group. The group management server provides the communication information to a provider of the service in response to a request from the service provider. The service provider performs communication related to the provision of the service with each of members by using the communication information.

### BACKGROUND OF THE INVENTION

1. Field of the Invention

The present invention relates to a method for implementing ad hoc groups by grouping persons, devices, and applications according to significant information and to a method for realizing a service referencing ad hoc group information.

2. Description of the Related Art

The development of IT technology has highly networked the modern society, with the result that various devices and entities have communication functions. In recent years, advances in micro-device technology have imparted a communication function even to an entity that has been irrelevant to a network and a networked ubiquitous society is just arriving. Ubiquitous is a word meaning “omnipresent”, which generally refers to the entire spectrum of technology related to a network to which various entities have been connected.

In the ubiquitous society, it is considered that full use of omnipresent computers enables various services. At present, a variety of service images are proposed. In an environment in which ubiquity has been realized, e.g., a service which supports communication in a more natural fashion or provides information in an appropriate manner through cooperation among a person, a device located around the person, and an associated application can be considered. As specific examples of the service, the following can be considered.

(a) Even when a camera is not provided in a personal computer (PC), a TV meeting is held by using a Web (World Wide Web) camera placed around the camera.

(b) Before pre-shooting observation is performed by using the Web camera, a person in a shooting range is asked for permission to take photographs with the Web camera by using equipment possessed by the person in the shooting range.

(c) When a user enters a meeting room, a screen for a schedule management application placed in the meeting room is automatically displayed for the convenience of the user.

To realize such a service, however, (1) a technology for recognizing the ambient situation of a communication target and (2) a technology for associating a person, an ambient device, and an application with each other are necessary. In spite of the easy vision of the service images, it is not easy to develop individual technologies for specifically realizing the services and devise an architecture synthesized by combining a variety of technologies so that the majority of the service images remain future research challenges.

For the example (1) mentioned above, there is a technology termed “awareness” which implements smooth communication by preliminarily “knowing” the presence or state of the target. The “awareness” is a technology which supports person-to-person communication. For the example (2) mentioned above, there is a technology with which devices present in a wireless communication range are automatically connected with each other by using a radio wave and a technology termed ad hoc routing.

The following is relating art documents related to the present invention.
[Patent document 1] JP 2000-305855 A
[Patent document 2] JP Hei 10-257064 A
[Patent document 3] JP 2001-74855 A
[Patent document 4] JP 2003-6104 A
[Patent document 5] JP 2000-270163 A
[Patent document 6] JP 2001-511427 A

The “awareness” described above is a technology aimed at recognizing the state of a communication target so that it is incapable of judging whether or not communication can be performed based on the relationship between the communication target and a person around the target or enabling communication by using a device not registered as a personal belonging of the communication target (such as a display located in the vicinity of the communication target).

In the technology associated with “radio wave and ad hoc routing” mentioned above, a radio wave is used so that the range in which devices can be grouped is limited to a range reachable by the radio wave. On the other hand, a plurality of groups cannot be formed within the range reachable by the radio wave. In addition, the technology does not allow association between a user and a device and connection with an application.

### SUMMARY OF THE INVENTION

An object of the present invention is to provide a technology which manages the members of an ad hoc group related to the provision of a service together with communication information for performing communication with each of the members and allows a service provider to provide a service to the members by using the communication information.

To solve the above problems, the invention adopts the following means. That is, according to a first aspect of the invention, there is provided a method for supporting service provision for causing a computer to perform: receiving a request for member registration to an ad hoc group related to provision of a service and performing a process of the member registration; managing ad hoc group information including communication information, the communication information including information indicating a method for communication with each of members registered in the ad hoc group; and providing the communication information to a provider of the service.

According to a second aspect of the invention, there is provided a system for supporting service provision, the system including: a group management server for managing ad hoc group information including communication information inclusive of information indicating a method for communication with each of members registered in an ad hoc group related to provision of a service; at least one first terminal for notifying the group management server of a member registration request for registering the first terminal or an external device located outside thereof in the ad hoc group; and a second terminal for referencing the ad hoc group information managed at the group management server and performing communication related to the provision of the service with each of the members of the ad hoc group by using the communication information included in the ad hoc group information.

According to a third aspect of the invention, there is provided an ad hoc group management server including: a storage unit storing ad hoc group information including communication information inclusive of information indicating a method for communication with each of members registered in an ad hoc group related to provision of a service; a management unit receiving, from a user terminal, a request for member registration of a device to be registered as the member of the ad hoc group and performing a process of the member registration with respect to the group information; and a group information provision unit providing the communication information included in the ad hoc group information to a provider of the service.

According to a fourth aspect of the invention, there is provided a user terminal including: a selection unit selecting an ad hoc group related to provision of a service; a notification unit for notifying, of a member registration request for registering the terminal or an external device existing outside thereof in the ad hoc group selected in the selection unit, a group management server for managing ad hoc group information including communication information inclusive of information indicating a method for communication with each of members registered in the ad hoc group; and a processing unit referencing, when the terminal has been registered in the ad hoc group, the ad hoc group information managed at the group management server and receiving and processing information related to the service from an application server for providing the service by using the communication information included in the ad hoc group information.

According to a fifth aspect of the invention, there is provided an application server including: a reference processing unit referencing communication information inclusive of information indicating a method for communication with each of members registered in an ad hoc group related to provision of a service and managed at a group management server; and a communication processing unit performing communication related to the provision of the service with each of the members by using the communication information.

In accordance with the present invention, it becomes possible to manage the members of an ad hoc group related to the provision of a service together with communication information for performing communication with each of the members and allow a service provider to provide a service to the members by using the communication information.

### BRIEF DESCRIPTION OF THE DRAWING

In the drawing, the subject-matter of the invention is represented by way of example, wherein:

FIG. 1 is a view showing a structural example of a system according to an embodiment of the present invention;

FIG. 2 is a functional block diagram of the system according to the embodiment of the present invention;

FIG. 3 is a view showing a structural example of data in communication information;

FIG. 4 is a view showing a structural example of data in a communication information list;

FIG. 5 is a view showing a structural example of data in ad hoc group information;

FIG. 6 is a view showing an example of a process flow in a communication application;

FIG. 7 is a view showing an example of a process flow in a group registration unit;

FIG. 8 is a view showing an example of a process flow in a group management unit;

FIG. 9 is a view showing an example of a process flow in a group selection unit;

FIG. 10 is a view showing an example of a process flow in a communication information notification unit;

FIG. 11 is a view showing an example of a process flow in a communication information reference unit;

FIG. 12 is a view showing an example of a process flow in a communication information registration unit;

FIG. 13 is a view showing an example of a group generation sequence;

FIG. 14 is a view showing an example of a communication information registration sequence;

FIG. 15 is a view showing an example of a group registration sequence;

FIG. 16 is a view showing an example of a group information reference sequence;

FIG. 17 is a view illustrating the process sequence of privacy protection (Application Example 1) from a monitor camera;

FIG. 18 is a view illustrating the process sequence of a meeting application (Application Example 2); and

FIG. 19 is a view illustrating the process sequence of a video phone application (Application Example 3).

### DESCRIPTION OF THE PREFERRED EMBODIMENT

Referring to the drawings, embodiments of the present invention will be described hereinafter. The structures described in the embodiments are only exemplary and the present invention is not limited to the structures of the embodiments.

### OUTLINE OF THE PRESENT INVENTION

The present invention provides means for allowing a person to reference group information (e.g., a meeting room, a user's personal belonging, a person around a desk) significant to a service without depending on a network topology, means for dynamically constructing virtual ad hoc groups based on the group information, and means for reporting in real time updated information on the members of the ad hoc groups to a person who references the group information. This enables the realization of various services using information on the ad hoc group.

The ad hoc groups are classified according to information (such as a place, a meeting name, and a personal belonging) significant to a service. Identification information for ad hoc groups is disclosed by a method not depending on the network topology (network structure).

As means for referencing a group, there can be considered “Reading of a group tag with a group identifier written therein by a device registered as a member”, “Selection of the group identifier by a device registered as a member which is performed by using an application in a higher-order layer not depending on the network topology (network structure)”, “Causing a sensor corresponding to the group identifier to sense a device registered as a member”, or the like.

Not only a device but also a person, a device used by a person, an application, significant information (e.g., a place) which motivates the significance of a group can be associated collectively. This allows various means to be used as means for communication with a person, which is different from a P2P (Peer-to-Peer) technology, an ad hoc group composed only of terminals using wireless ad hoc, and an ad hoc group based only on user accounts provided on the Internet.

As a result, it becomes possible to make a judgment with higher awareness on a member registered in an ad hoc group based on the peripheral situation of a user and on a service targeted by the ad hoc group.

<Outline of System Function>

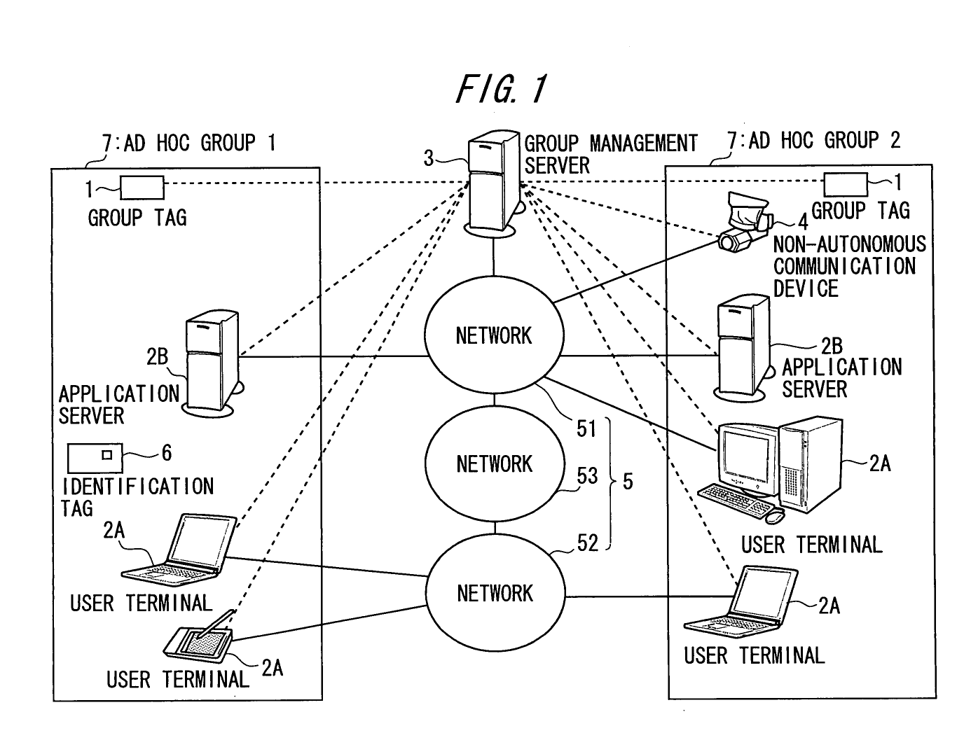

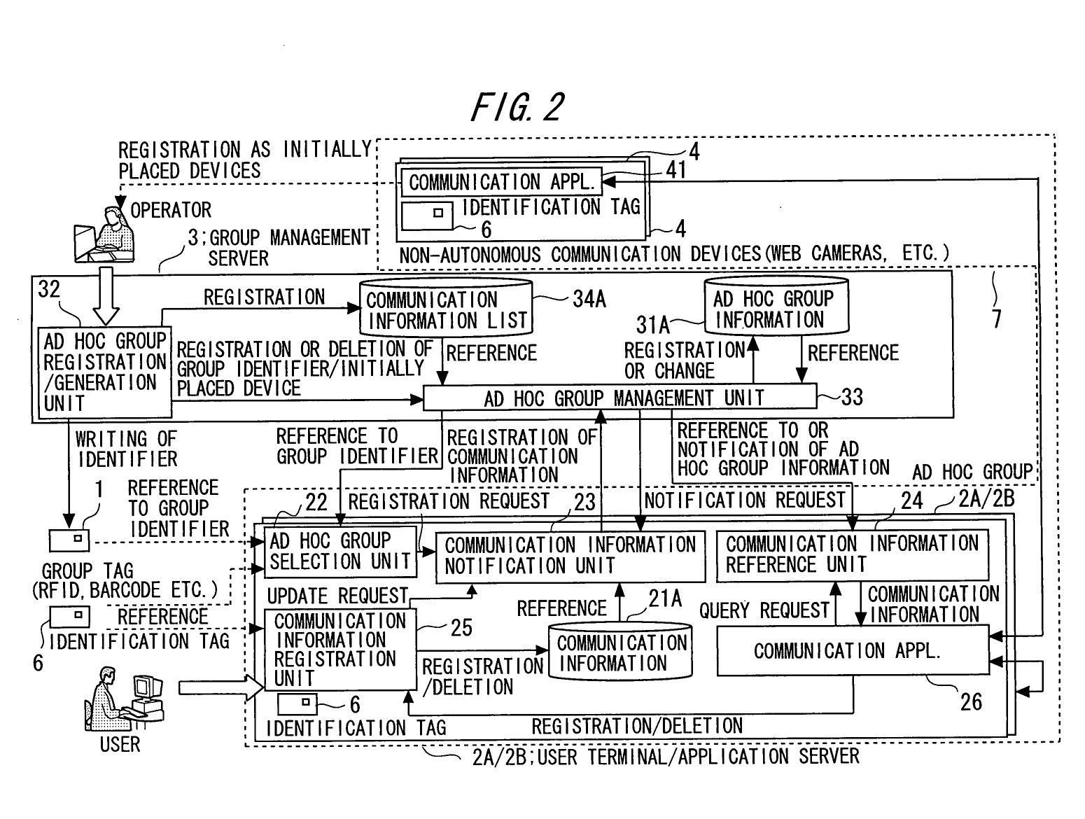

FIG. 1 shows a structure of a system (ad hoc group management/service provision system) based on an embodiment of the present embodiment. FIG. 2 is a block diagram illustrating the functions possessed by the system shown in FIG. 1. A description will be given hereinafter to the devices composing the system.

It is to be noted that the respective functions possessed by a group management server 3, a user terminal 2A, and an application server 2B illustrated in FIG. 2 show implementation examples for the convenience of description and the present invention is not limited to such an arrangement of functions.

A group tag 1 and an identification tag 6 are also not limited to those illustrated in the example shown in FIG. 2 and they are implementable by using any sensor technology allowing the sensing of information stored in the tags 1 and 6.

<<Group Tag>>

The group tag 1 is a tag in which identification information for ad hoc groups allocated to the group management server 3 has been written. Devices registered as members of each of ad hoc groups 7 reference the identification information (identifiers) for the group by reading the information stored in the group tag 1. Briefly, the group tag 1 may be constructed appropriately to store therein the identification information for the group such that it is readable by a reader provided in each of the devices registered as members.

In other words, the group tag 1 is constructed as a recording medium from which the group information can be read by the devices registered as the members. Accordingly, the reader may be provided appropriately in each of the devices to be capable of reading the group information through contact or non-contact with the group tag 1. For example, it is possible to use, as the group tag 1, a recording medium (such as a sheet) with, e.g., an RFID (Radio Frequency Identification) tag or a barcode printed thereon, a nonvolatile memory (a disk memory, a memory card, or the like), an information processor having the group information stored therein, or the like.

<<User Terminal/Application Server>>

Each of the user terminal 2A and the application server 2A has the function (member registration function) of notifying the group management server 3 of communication information for performing communication with a registrant (a device registered as a member) in association with a group identifier and the function (communication information acquisition function) of acquiring the communication information from the group management server 3 to perform communication with another user terminal 2A or application server 2B.

The user terminal 2A indicates a terminal used personally by a user, while the application server 2B indicates a terminal used a plurality of persons, such as a WEB server. As terminals, various information processors (computers) such as a PC, a work station (WS), a dedicated server machine, a PDA, and a mobile telephone can be used.

Each of the user terminal 2A and the application server 2B is allowed to become a device registered as a member of an ad hoc group specified by a group identifier by performing the member registration function.

<<Ad Hoc Group Management Server>>

The ad hoc group management server (group management server) 3 issues the group identifier of an ad hoc group. The group management server 3 also manages the registration, deletion, and update of the group information including the communication information on the members of each of groups. In addition, the group management server 3 provides the user terminal 2A or the application server 2B with the communication information responding to a request therefrom.

The group management server 3 is constructed by equipping an information processor such as a PC, WS, or a dedicated server machine with the function of implementing the group management server 3. Alternatively, the group management server 3 may also be constructed by equipping an information processor functioning as the user terminal 2A or the application server 2B with the function of implementing the group management server 3. The group management server 3 may also be placed to manage one or more groups or may be prepared for each of groups.

<<Non-Autonomous Communication Device>>

Anon-autonomous communication device 4 is a device (terminal) which does not have the member registration function or the communication information acquisition function each possessed by the user terminal 2A and the application server 2B.

When a group identifier is generated, the non-autonomous equipment 4 is registered as an initially registered device in the group by the generator of the group identifier. At this time, information (communication information) for performing communication with the non-autonomous communication device 4 is registered as the group information.

The non-autonomous device 4 is activated only by an activation request from another device such as the user terminal 2A or the application server 2B and does not autonomously perform communication.

The generation of the group identifier may be performed by a manual process or by an automatic process using an application for the automatic generation of a group identifier.

<<Network>>

A network 5 (in FIG. 1, three networks 51, 52, and 53 are shown by way of example) is a network used by the group management server 3, the user terminal 2A, and the application server 2B to perform communication.

In implementing the present invention, the type of a network composing the network 5 is not limited. However, a plurality of networks composing the network 5 are coupled to each other and should have compatibility in a higher-order layer in an OSI (Open Systems Interconnection) reference model (for example, layers not lower than Layer 3 are unified based on IP), while it is sufficient for each of lower-order layers to have a structure specific to the network. For example, the network 5 shown in FIG. 1 can be constituted by the network 51 using a wired LAN (Local Area Network), the network 52 using a wireless LAN or a mobile phone network, and the network 53 using the Internet.

<<Identification Tag>>

The identification tag 6 is an ID card for the identification of a user or a tag for the identification of a device. The identification tag for the user is used to allow easy registration of the user information in the communication information.

On the other hand, the identification tag for the device is used when the user terminal 2A or the application server 2B reads the identification tag of a device (an external device) located outside thereof and performs member registration.

<<Ad Hoc Group>>

The ad hoc groups 7 are virtual groups composed dynamically of devices that have referenced group identifiers issued from the group management server 3. The members of each of the ad hoc groups are unfixed and a change in the group is reported in real time to a person who references (such as the user of the user terminal 2A or the application server 2B) the group information.

Each of the devices (the user terminal 2A, the application server 2B, and the non-autonomous communication device 4) becoming members may also belong to a plurality of ad hoc groups.

The ad hoc groups 7 are groups significant to the service and are constructed preferably such that they incur no constraint placed by constructing the ad hoc groups 7 other than the service using the information on the ad hoc groups 7.

<Description of Data and Transactions>

A description will be given next to data and transactions in the functional blocks shown in FIG. 2. Hereinafter, it is assumed that an item classified as data is recorded in a nonvolatile memory (such as an EEPROM (Electronically Erasable and Programmable Read Only Memory) or a hard disk) and the content thereof is changed by writing/reading means for data. An item classified as a transaction is recorded in a volatile memory (such as a RAM (Random Access Memory)). The contents of transactions are changed dynamically through the execution of the functions implementing the present invention.

<<Communication Information>>

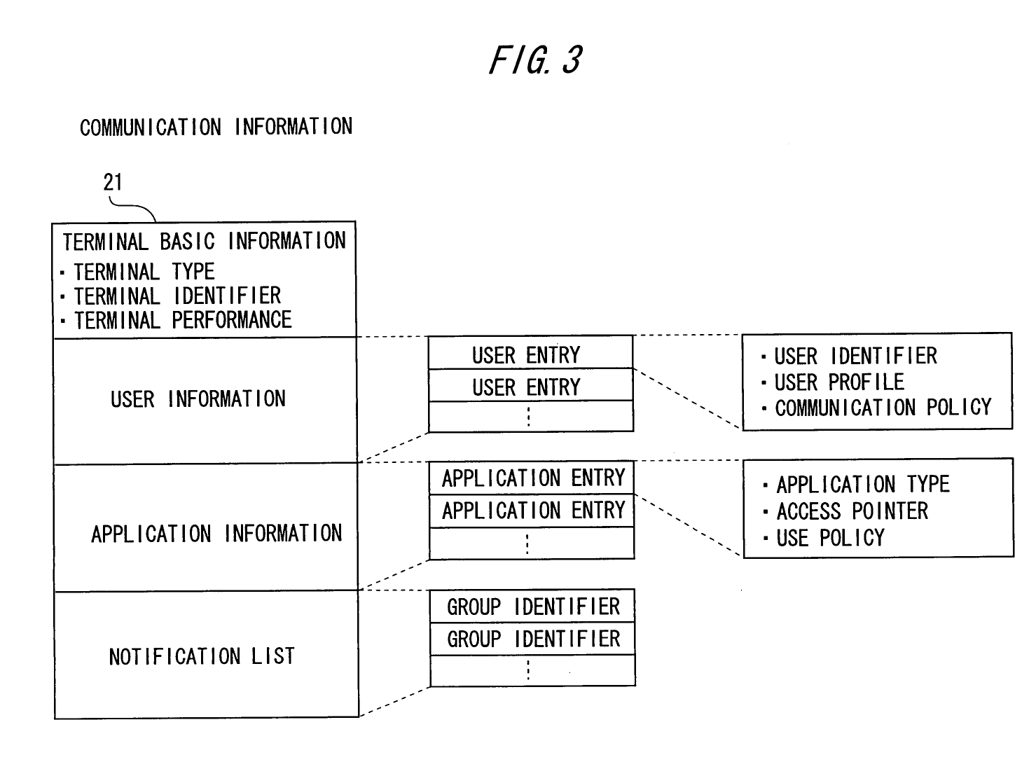

FIG. 3 shows a structural example of communication information. In FIG. 3, communication information 21 is a transaction composed of terminal basic information, user information, application information, and a notification list. The communication information has a data structure consisting of a plurality of fields having a hierarchical structure as shown in FIG. 3.

The terminal basic information is awareness information referenced when a communication application 26 (FIG. 2) possessed by the user terminal 2A or the application server 2B selects a terminal (device) with which it will perform communication.

The terminal basic information is composed of, e.g., the type of a terminal (a PC, a PDA, a mobile phone, a cellular phone, or the like), a terminal identifier (an IP address, a phone number, or the like), and terminal performance (a communication speed, the presence or absence of a display, the resolution of a display, the presence or absence of a sound device, or the like). These items of information are preliminarily registered as initially registered data in the nonvolatile memory of the terminal and loaded into the record area (produced on the volatile memory: the storage portion 21A of FIG. 2) of the communication information 21 upon the activation of the system.

The user information is information on a user who uses the terminal (i.e., a device registered as a member), which is dynamically registered by the user using the terminal. The user information is composed of a plurality of user entries.

One terminal (device) may also be shared by a plurality of users. As an example of such a use, there is a case where a large-scale display placed in a meeting room is used by a plurality of attendants.

The user entry is composed of a user identifier (user ID) a user profile, and a communication policy. The user identifier is identification information for a user which is unique throughout the entire system. The user profile is display information indicative of the user to which, if necessary, additional information necessary for a service (such as a company name or post) and the like are imparted. The communication policy is information for specifying the range in which the identity of the user as a member of a group is disclosed to the referencer of the group, a policy for determining priorities among a plurality of devices in use, and the like.

If the users of the terminal are fixed, the user entries may also be registered as initially registered data in the nonvolatile memory of the terminal such that they are loaded into the record area of the communication information 21 upon the activation of the system, similarly to the terminal basic information.

The application information is information showing a method for accessing an application operating on a terminal to a person who references information on an ad hoc group (i.e., the group information). The application information is registered in the record area of the communication information 21 upon the activation of the application.

The application information is composed of one or more application entries in accordance with one or more communication means usable on one terminal (device). A communication application which implements the communication means is an application using such a technology as a Mailer, a Web Browser, a VOIP (Voice over IP) application, a specific application based on socket communication, CORBA (Common Object Request Broker Architecture), or a WEB Service.

The application entry is composed of an application type, an access pointer, and a use policy. The application type is identification information indicative of the type of a communication application as described above. The access pointer is an access pointer (such as an IP address and a port number, UDDI (Universal Description, Discovery, and Integration), or a mail address) in accordance with the type of the communication application. The use policy includes information for limiting the user of the communication application to the members of the same group or limiting the disclosure of information related to the communication application.

The notification list records the group identifiers in association with which the communication information 21 is registered. The notification list is used to update the information on the group which has been notified of the communication information 21 when the communication information 21 is changed by the addition or deletion of a user, the new activation or halt of a communication application, or the like.

<<Communication Information List>>

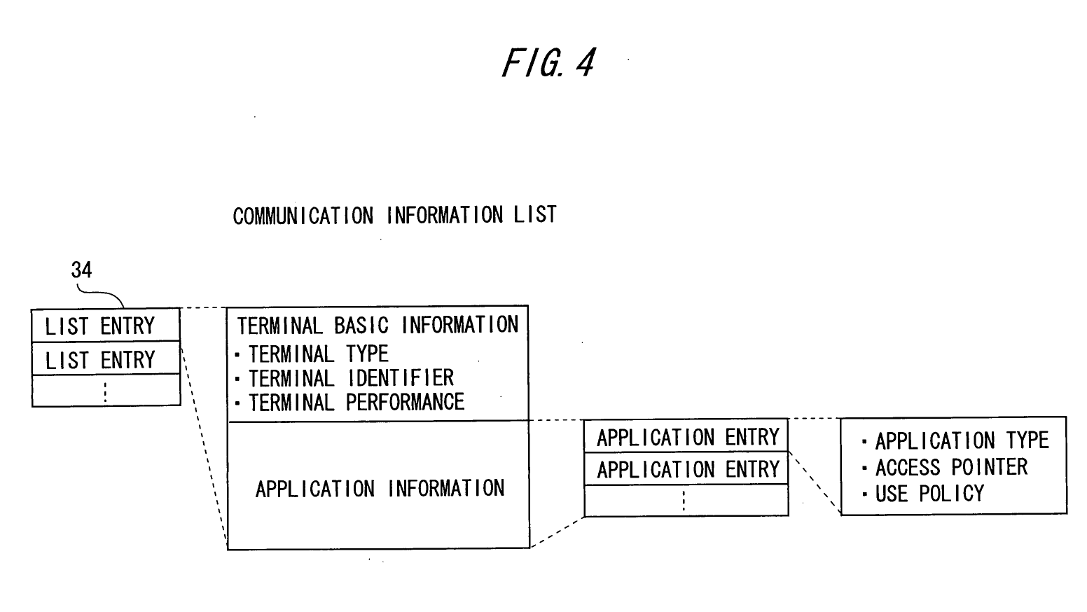

FIG. 4 shows a structural example of the communication information list 34. The communication information list 34 is data storing therein the communication information of the non-autonomous communication devices 4. The communication information list 34 is a subset of the communication information 21, which is obtained by removing the user information and the notification list from the communication information 21.

<<Group Information>>

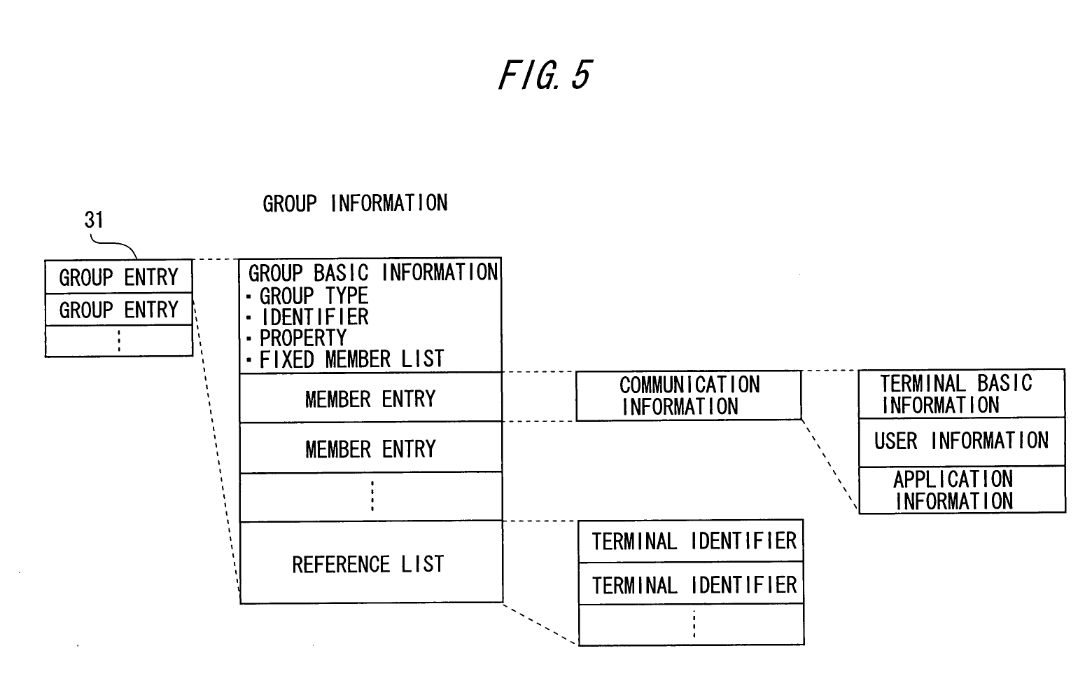

FIG. 5 shows a structural example of the group information 31. The group information 31 is a transaction composed of group entries prepared for individual groups in a one-by-one correspondence. Each of the group entries is composed of respective fields for storing group basic information, a member entry, and a reference list.

The group basic information is composed of a group type, a group identifier, a property, and a fixed member list. The group type is information indicative of the type of a group (such as a place, a post, or a meeting). The group identifier is an identifier for uniquely identifying the group throughout the system. The property includes the objective of the group, display information on an application, and the like. The fixed member list is a directory of the identifiers of the fixed members of the group.

The member entry is a partial copy (obtained by removing the notification list from the communication information 21 (i.e., the terminal basic information, the user information, and the application information)) of the communication information 21 reported from the user terminal 2A or the application server 2B and/or information (the terminal basic information and the application information) loaded from the communication information list 34 in response to a registration request from the user terminal 2A or the application server 2B.

The member entries of the fixed members are set by setting information directly to the entries at the time of group formation or by loading information from the communication information list 34.

The reference list shows a directory of the user terminals 2A/application servers 2B which are referencing the group and is composed of a set of the corresponding terminal identifiers. The reference list is used to notify the referencers of the update of the communication information.

### DETAILED DESCRIPTION OF FUNCTIONAL BLOCKS

A description will be given next to each of the functional blocks shown in FIG. 2. The entity of each of the functional blocks, which will be described below, is a program read from a nonvolatile memory (such as a hard disk) into a memory (such as a RAM (Random Access Memory)) upon the activation of the system and executed by a central processing unit (CPU) provided in each of devices functioning as the group management server 3, the user terminal 2A, the application server 2B, and the non-autonomous communication device 4. However, there is also a functional block which uses, as a device, a sensor such as an RFID reader.

In the example shown in FIG. 2, each of the user terminal 2A and the application server 2B functions as a device including the storage portion 21A of the communication information 21 (FIG. 3) an ad hoc group selection unit (group selection unit) 22, a communication information notification unit 23, a communication information reference unit 24, a communication information registration unit 25, and the communication application 26.

On the other hand, the group management server 3 functions as a device including a storage portion 31A of the group information 31 (FIG. 5), an ad hoc group registration/generation unit 32, an ad hoc group management unit 33, and the storage portion 34A of the communication information list 34 (FIG. 4).

The non-autonomous communication device 4 functions as a device containing a communication application. 41. Hereinafter, the function of each of the blocks and a process therein will be described in detail.

<<Communication Application>>

The communication applications 26 and 41 provided in the user terminal 2A, the application server 2B, and the non-autonomous communication device 4 are entities which reference the group information managed at the group management server 3 and provide a service using the group information.

However, the communication application 41 operating on the non-autonomous communication device 4 is activated only by an access from the communication application 26 of another terminal.

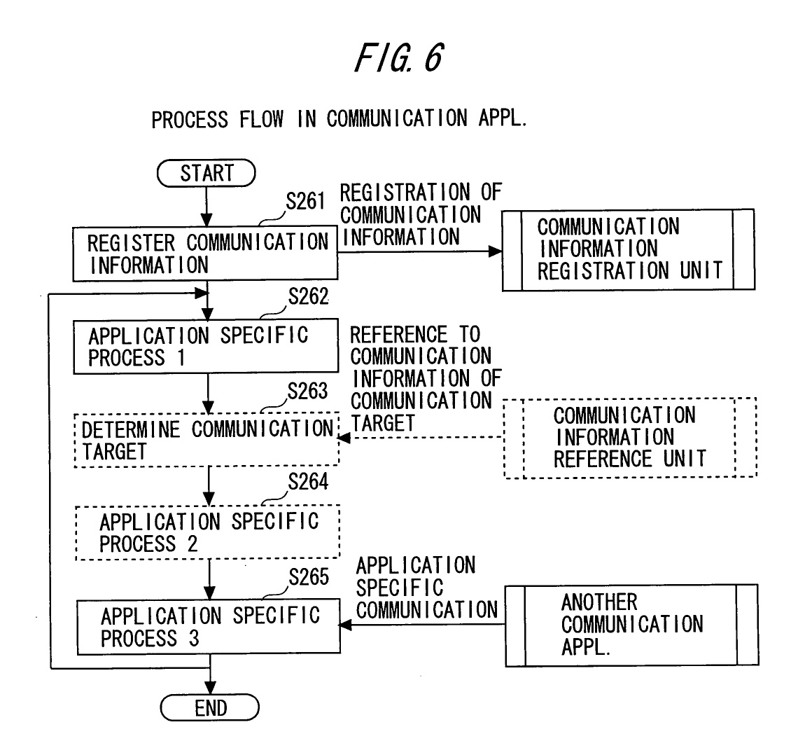

FIG. 6 shows an example of a process flow in the communication application 26. In FIG. 6, the communication application 26 operating on the user terminal 2A or the application server 2B registers, upon activation, the communication information for accessing the communication application in the storage portion 21A via an API (Application Program Interface) provided by the communication information registration unit 25 (Step S261).

In Step S262, the communication application 26 performs a process specific to the application such as the provision of a GUI (Graphical User Interface) to the user. The GUI is provided via the display unit or input unit possessed by the user terminal 2A/application server 2B.

In Step S263, the communication application 26 references, if necessary, information on a group and the members of the group required thereby via the communication information reference unit 24 and determines a communication target.

In Step S264, the communication application 26 references, if necessary, the awareness information (the communication policy and the use policy) for the determined communication target and performs the changing of the communication target or a preliminary negotiation (such as asking a communication permission from the target).

In Step S265, the communication application 26 performs communication in accordance with a method specified by the communication application and communication information of the finally determined communication target. Depending on the application, the whole process may return to Step S262 to receive an instruction from the user again.

<<Group Registration/Generation Unit>>

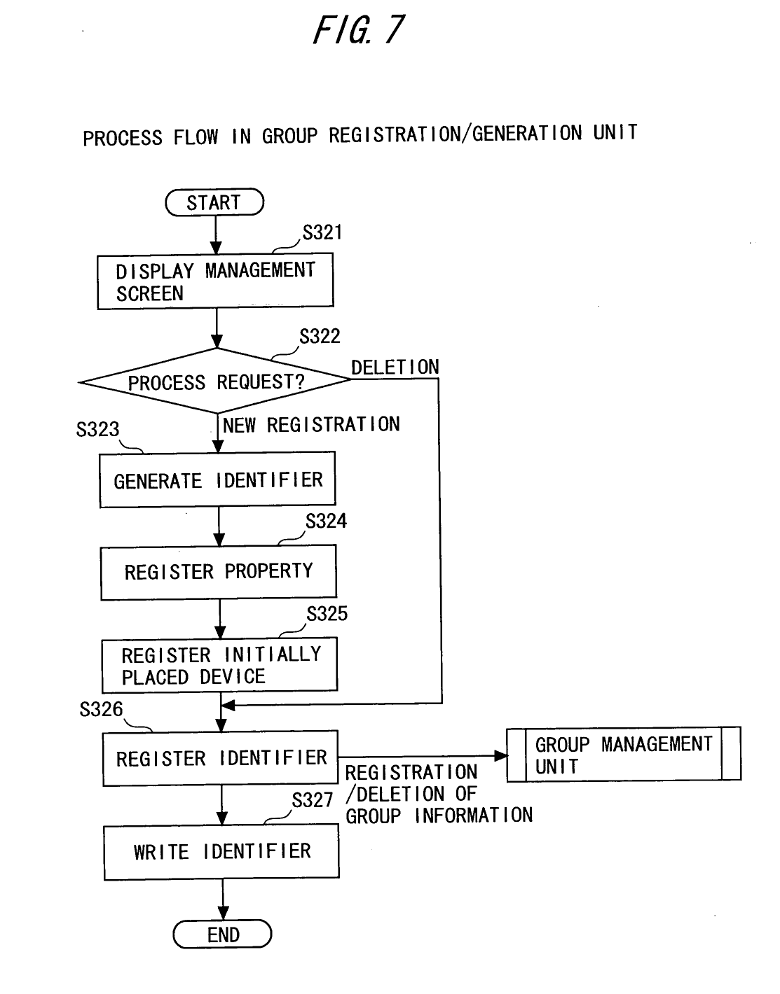

The group registration/generation unit 32 dynamically generates or deletes an ad hoc group in association with significant information. FIG. 7 shows an example of a process flow in the group registration/generation unit 32.

In Step S321 of FIG. 7, the group registration/generation unit 32 displays a management screen for ad hoc groups to a user (operator) The management screen is displayed on a display device (not shown) connected to the group management server 3.

In Step S322, the group registration/generation unit 32 judges a process request inputted by the user via the management screen. At this time, if the process request is for new registration, the whole process advances to Step S323. If the process request is for deletion, the whole process advances to S326.

In Step S323, the group registration/generation unit 32 generates a value unique throughout the system as a group identifier and sets the generated value as an input parameter to the group management unit 33.

In Step S324, the group registration/generation unit 32 sets a group type and a property specified by the user as input parameters to the group management unit 33.

In Step S325, the group registration/generation unit 32 sets, to the member entries, the communication information of the initially registered devices, which are the fixed members of the group, as an input parameter to the group management unit 33 or registers the communication information in the communication information list.

In Step S326, if the process request is for new registration, the group registration/generation unit 32 notifies the group management unit 33 of the registration request by using the group entry information as a parameter. If the process request is a deletion request, on the other hand, the group registration/generation unit 32 notifies the group management unit 33 of the deletion request by using the group identifier as a parameter.

In Step S327, the group registration/generation unit 32 writes the generated identifier in the group tag, if it is specified by the user. As specific examples of the writing of the identifier in the group tag, there can be used the process of (1) writing the identifier in an RFID tag, (2) printing the barcoded identifier onto a sheet such as paper, (3) printing an identification code directly onto a sheet such as paper, (4) transmitting the identifier to a device with a display function specified by the user and displaying a barcode or an identification code thereon, or the like.

<<Group Management Unit>>

The group management unit 33 registers the group information generated by the group registration/generation unit 32 in the group information transaction (the storage portion 31A). The group management unit 33 also receives a request for member registration in the group from each of the user terminal 2A and the application server 2B and registers the request in the corresponding group information.

In addition, the group management unit 33 discloses information in response to an inquiry about the group information from the user terminal 2A or the application server 2B. The group management unit 33 also notifies, when the communication information is updated, the user terminal 2A or the application server 2B which is currently referencing the group information of the update of the communication information.

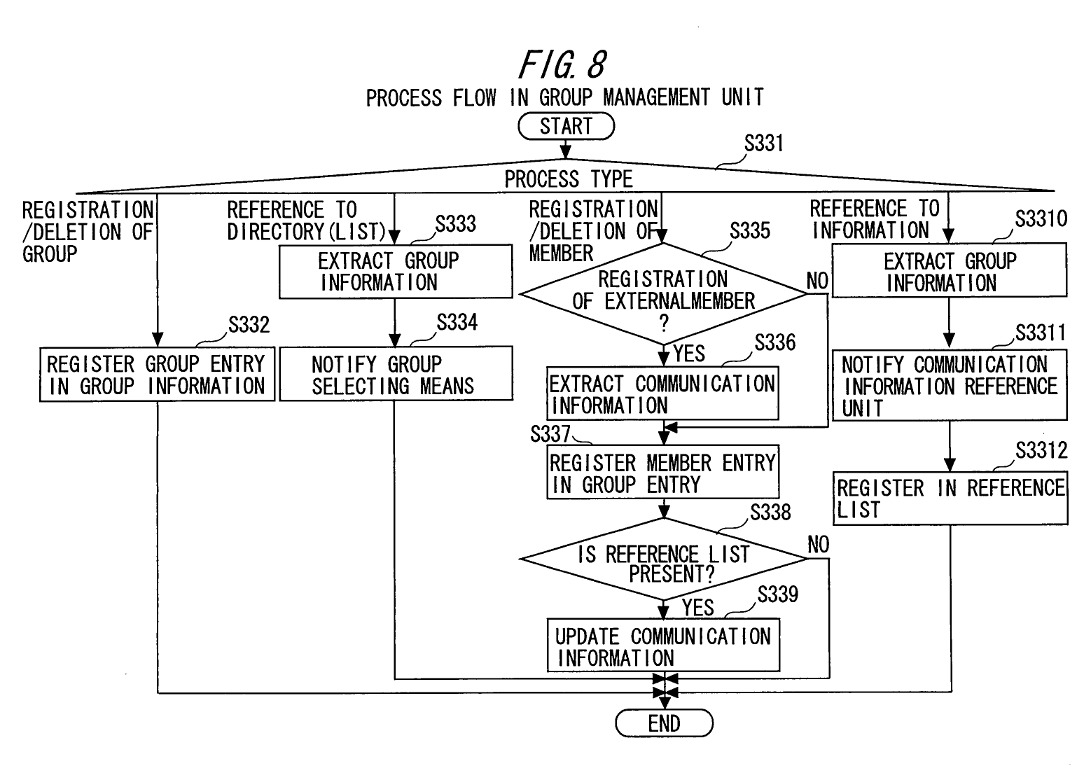

FIG. 8 is a flow chart showing an example of a process in the group management unit 33. In Step S331 of FIG. 8, the group management unit 33 determines the type of a process request inputted thereto. At this time, if the process request is for group registration/deletion, the whole process advances to Step S332. If the process request is for reference to the directory, the whole process advances to S333. If the process request is for member registration/update, the whole process advances to step S355. If the process request is for information reference, the whole process advances to Step S3310.

In Step S332, if the process request is for group registration, the group management unit 33 adds the group entry reported as an input parameter to the group registration unit 32 to the group information transaction (the storage portion 31A: FIG. 5).

At this time, if the fixed member list has been set to the group entries, the group management unit 33 searches the communication information list 34 (FIG. 4) with the terminal identification information shown by the fixed member list and copies the obtained information in the member entries of the group entry.

In Step S332, if the process request is for group deletion, the group management unit 33 deletes the group entry corresponding to the target of deletion from the group information transaction (the storage portion 31A: FIG. 5).

In Step S333, the group management unit 33 references, in response to the process request for reference to the directory, the group information transaction (the storage portion 31A) within the range specified by the user terminal 2A or the application server 2B which has requested the reference to the directory and extracts the target group information.

In Step S334, the group management unit 33 notifies the group selection unit 22 of the user terminal 2A or the application server 2B corresponding to the requester of the group information extracted from the storage portion 31A.

In Step S335, if the process request is for member registration/update and also for external member registration (the registration of an external device as a member performed by the requester of the process through the reading of an RFID attached to the device by using an RFID reader) (S335; YES), the group management unit 33 advances the whole process to Step S336. If not (S335; NO), the group management unit 33 advances the whole process to Step S337.

In Step S336, the group management unit 33 references the communication information list 34 or sends a notification request to the user terminal 2A or the application server 2B and extracts (acquires) the communication information necessary for registration in the group entry.

In Step S337, the group management unit 33 sets the communication information as a member entry to the corresponding group entry in the group information transaction.

In Step S338, the group management unit 33 references the reference list of the group entry. If the list of terminal identifies has been set (S338; YES), the group management unit 33 advances the whole process to Step S339. If not (S338; NO), the group management unit 33 ends the whole process.

In Step S339, the group management unit 33 performs the update of the communication information (reports the content of the update) with respect to the communication information reference unit 24 of the terminal (the user terminal 2A/application server 2B) having the terminal identifier extracted from the reference list.

In Step S3310, the group management unit 33 extracts, in response to the process request for reference to information, the group information (at least one group entry) specified by the user terminal 2A or the application server 2B that has requested the reference to information (requester terminal) from the group information transaction (the storage portion 31A).

In Step S3311, the group management unit 33 notifies the communication information reference unit 24 of the requester terminal of the communication information. In Step S3312, the group management unit 33 registers the terminal identifier of the requester terminal in the reference list of the group entry as the target of the reference to information.

<<Group Selection Unit>>

The group selection unit 22 has the function of automatically extracting a group identifier from the group tag 1 by using an RFID reader or the like or the function of showing a group directory to a user in cooperation with the group management unit 33 of the group management server 3 such that the user selects a desired group.

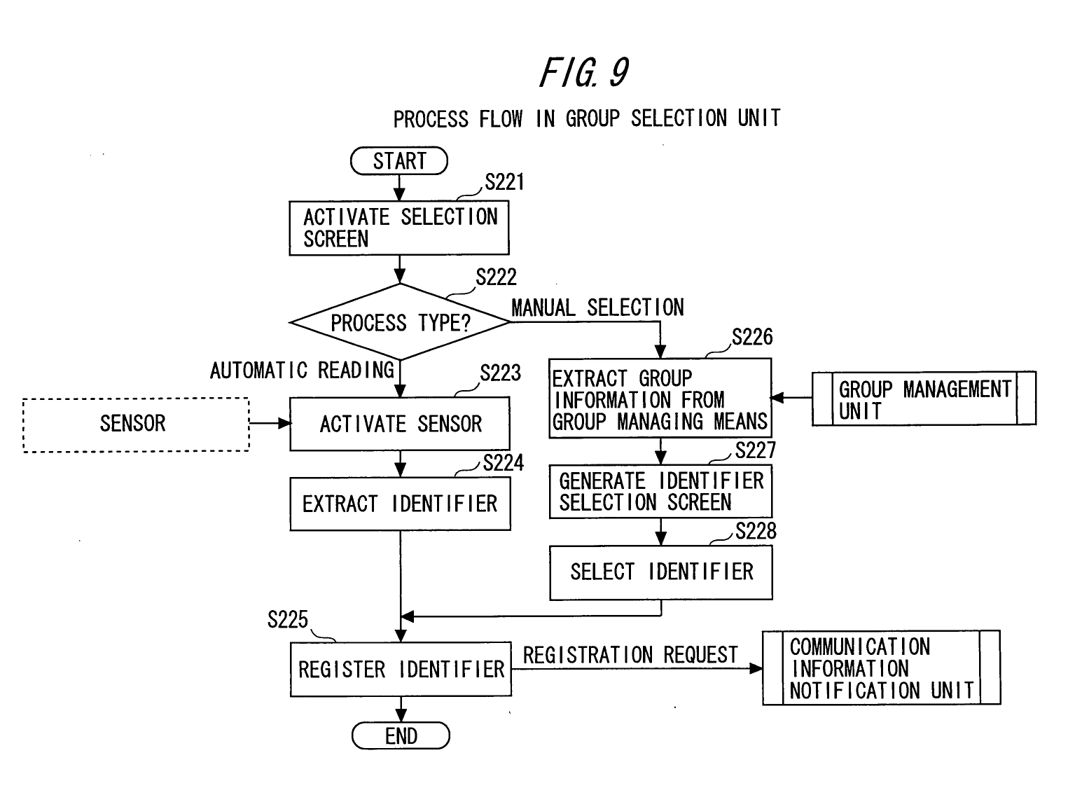

FIG. 9 shows an example of a process flow in the group selection unit 22. In Step S221 of FIG. 9, the group selection unit 22 generates a selection screen for notifying the user to specify means for group selection and presents the selection screen to the user (shows the selection screen on a display device).

In Step S222, if the process type selected (specified) by the user is “automatic reading”, the group selection unit 22 advances the whole process to Step S223. If the process type selected by the user is “manual selection”, the group selection unit 22 advances the whole process to Step S226.

In Step S223, if the process is automatic reading, the group selection unit 22 activates a sensor subordinate to the group selection unit 22 and reads the group tag 1. The group tag 1 is a tag with a group identifier printed thereon as a barcode, an RFID tag with the group identifier written therein, or the like. The sensor is an optical scanner for reading the barcode, an RFID reader for acquiring the group identifier from the RFID tag by wireless communication, or the like.

In Step S224, the group selection unit 22 extracts the group identifier from the information sensed by the sensor. In Step S225, the group selection unit 22 notifies the communication information notification unit 23 of the extracted group identifier as a registration request.

In Step S226, if the process is manual selection, the group selection unit 22 sends a process request for reference to the directory to the group management unit 33 of the group management server 3. In short, the group selection unit 22 acquires the group information transmitted from the group selection unit 33.

In Step S227, the group selection unit 22 generates a group identifier selection screen based on the extracted group information and shows the selection screen on the display device (presents the selection screen to the user). In Step S228, the group selection unit 22 receives the group identifier selected (specified) by the user via the identifier selection screen. Thereafter, the whole process advances to Step S225.

As another method for implementing Steps S223, S224, and S225 described above, there is a method in which a device (terminal) embedded with a sensor preliminarily records group identifiers in the memory thereof and reads in the identification tag 6 possessed by a device (external device) to be registered as a member. In this case, identification information for the external device which indicates the registration of the external member is given as a parameter for a registration request given to the communication information notification unit 23 in Step S225.

<<Communication Information Notification Unit>>

The communication information notification unit 23 notifies, when the group identifier is referenced, the group management server 3 for managing the referenced group identifier of the information in the communication information transaction (the storage portion 21A).

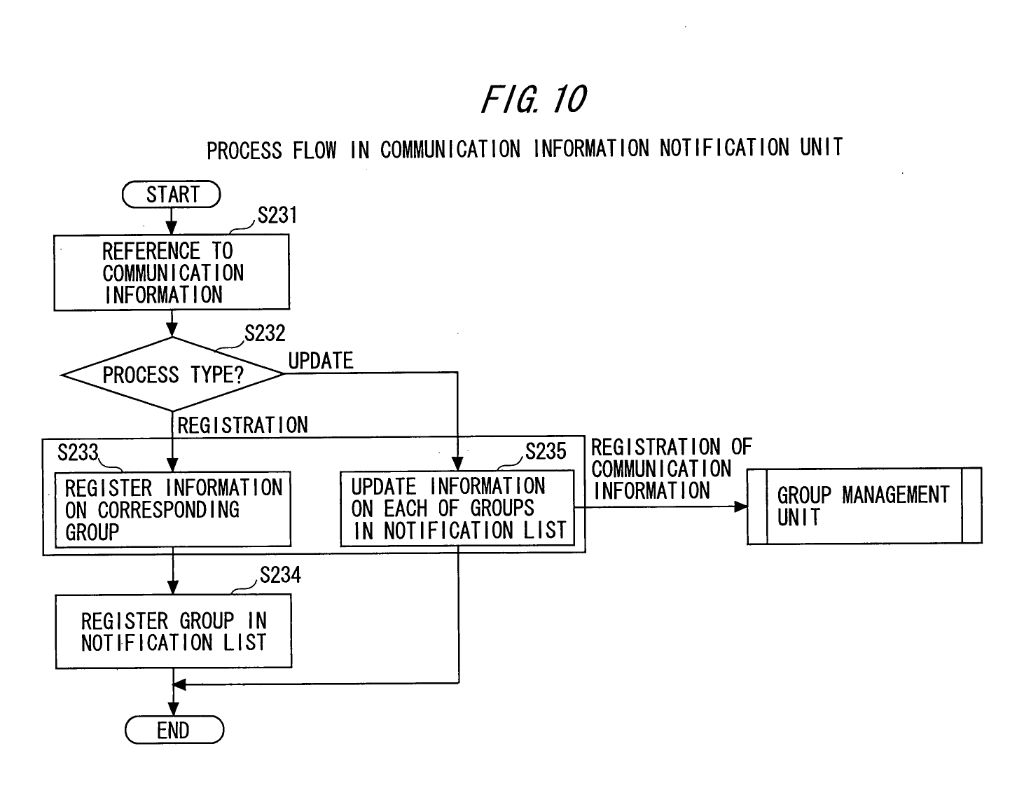

FIG. 10 shows an example of a process flow in the communication information notification unit 23. In Step S231 of FIG. 10, the communication information notification unit 23 references the communication information 31 (FIG. 3) and extracts (acquires) the communication information to be registered in the group management server 33.

In Step S232, if the process type is a registration request, the communication information notification unit 23 advances the whole process to Step S233. If the process type is an update request, the communication information notification unit 23 advances the whole process to Step S235.

In Step S233, if the process type is a registration request, the communication information notification unit 23 requests, of the group management unit 33 of the group management server 3, the registration (member registration) of the communication information using the group identifier reported from the group selection unit 22 and the communication information extracted (acquired) in Step S231 as parameters.

In Step S234, the communication information notification unit 23 registers the group identifier for which it has requested the registration of the communication information in the notification list (FIG. 3) of the communication information 21.

In Step S235, if the process type is an update request, the communication information notification unit 23 references the notification list of the communication information 31. The communication information notification unit 23 requests, of the group management unit 33 of the group management server 3 for managing each of the group identifiers, the registration of the communication information using the group identifier reported from the group selection unit 22 and the communication information extracted in Step S231 as parameters for every group identifier stored in the notification list.

<<Communication Information Reference Unit>>

The communication information reference unit 24 monitors in real time the group information managed at the group management unit 33 of the group management server 3 based on a query request from the communication application 26. If the communication information reference unit 24 finds the communication information which matches a query condition, it notifies the communication application 26 of the communication information.

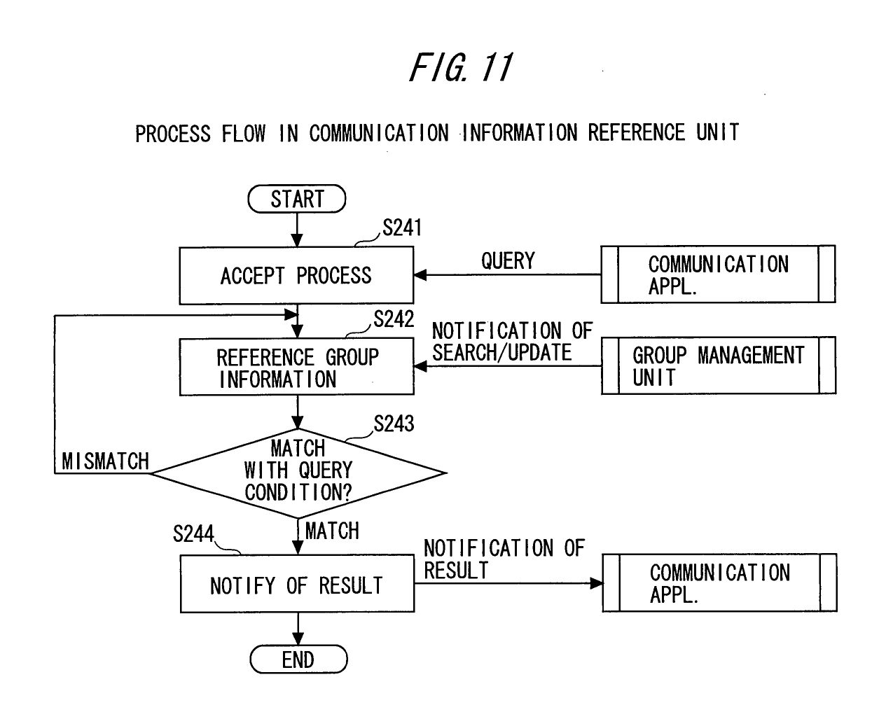

FIG. 11 shows an example of a process flow in the communication information reference unit 24. In Step S241 of FIG. 11, the communication information reference unit 24 monitors the query request from the communication application 26 and accepts it when it comes.

In Step S242, the communication information reference unit 24 extracts information on the group and the members thereof specified by the query from the group management unit 33 of the group management server 3.

In Step S243, if the extracted information on the group and the members thereof matches the condition specified by the query, the communication information reference unit 24 advances the whole process to Step S244.

In Step S243, if the extracted information does not match the query condition, the communication information reference unit 24 advances the whole process to Step S242 and awaits the notification of the update from the group management unit 33.

In Step S244, the communication information reference unit 24 notifies the communication application 26 of the extracted communication information of the group and the members thereof.

<<Communication Information Registration Unit>>

The communication information registration unit 25 registers the user information from the user that has been inputted either automatically or manually and the application information reported from the communication application 26 in the storage portion 31A of the communication information 31.

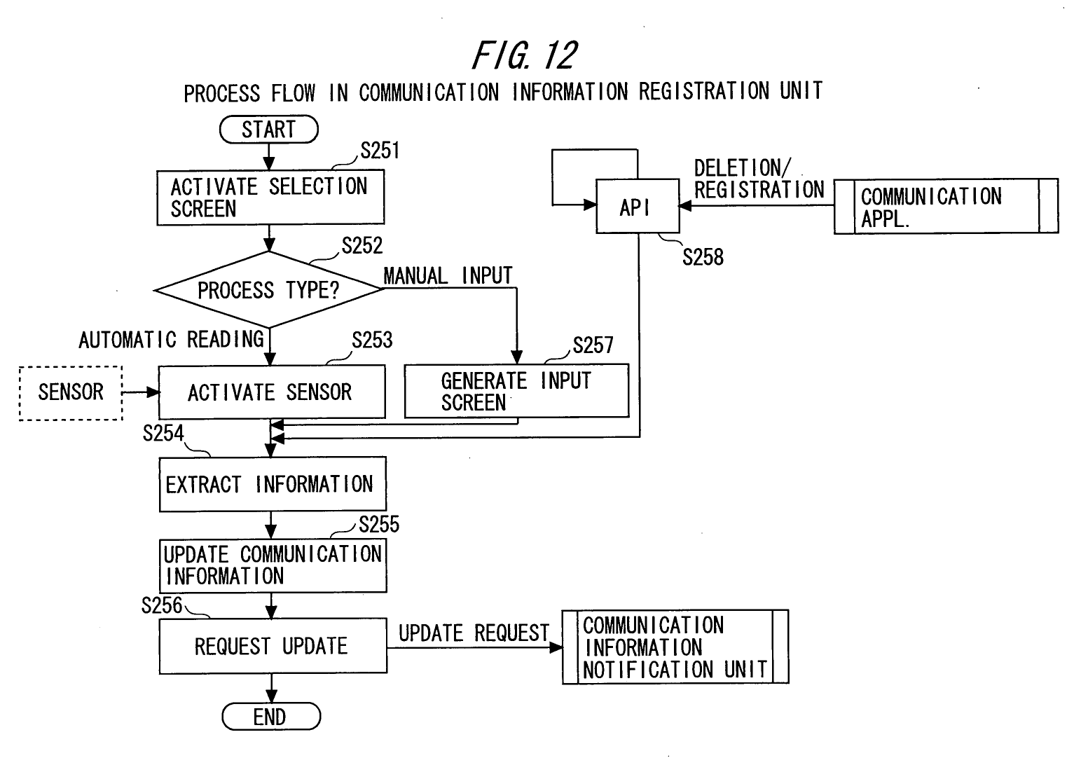

FIG. 12 shows an example of a process flow in the communication information registration unit 25. In Step S251 of FIG. 12, the communication information registration unit 25 shows a selection screen for notifying the user to input the user information on the display screen of a display device not shown.

In Step S252, if the process type selected on the selection screen is “automatic reading”, the communication information registration unit 25 advances the whole process to Step S253. If the process type selected is “manual input”, the communication information registration unit 25 advances the whole process to Step S257.

In Step S253, if the process type is automatic reading, the communication information registration unit 25 activates a sensor. The sensor is an ID card reader, an RFID reader, or the like. The user performs automatic reading by causing the sensor to sense the user information stored preliminarily in the ID card or RFID tag having the preliminarily stored user information.

In Step S257, if the process type is manual inputting, the communication information registration unit 25 generates an input screen for the inputting of the user information and displays the input screen on the display screen of a display device not shown.

In Step S258, the communication application 26 performs the registration/deletion of the application information via an API provided by the communication information registration unit 25. The API is operating independently of the process in Steps S251 to S256 and constantly monitoring a request from the communication application 26.

In Step S254, the communication information registration unit 25 extracts the user information that has been automatically read or manually inputted or the application information reported from the communication application 26.

In Step S255, the communication information registration unit 25 updates the target entry (the user entry or the application entry) in the communication information transaction (the storage portion 31A).

In Step S256, the communication information registration unit 25 transmits an update request to the communication information notification unit 23 to report the update of the communication information.

<Process Outline>

Hereinafter, a description will be given to the process outline of group generation, registration, and reference with respect to a sequence diagram and the process flow in each of the functional blocks already described.

[A. Group Construction Method]

[A-1. Group Generation]

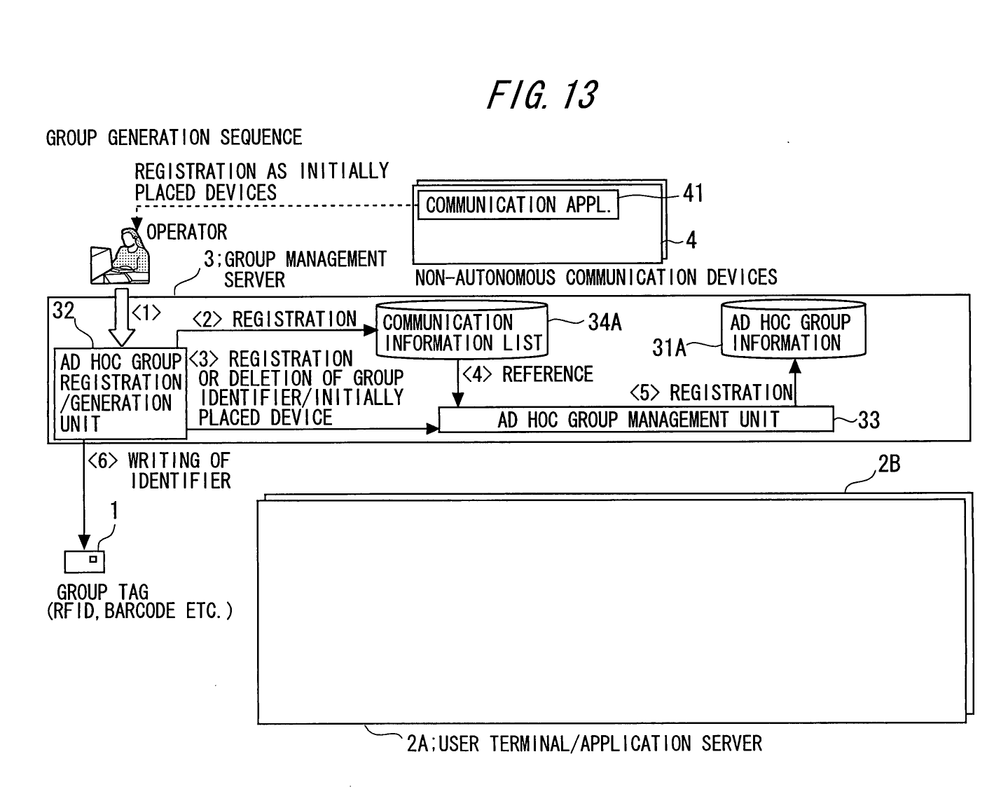

FIG. 13 shows an example of a group generation sequence. The sequence shown in FIG. 13 is as follows.

<1> An operator of the group management server 3 activates the group registration/generation unit 32 to generate a group. The operator inputs information necessary for the generation of the group by using the group management screen displayed on the display device (FIG. 7; S321, S322, S323, and S324). At this time, the operator inputs the group basic information (at least the group identifier). The operator also inputs, if the group has an initially registered device, the information thereon (the terminal identification information and the application information).

<2> If the information on the initially registered device is inputted by the operator, the group registration/generation unit 32 registers the information on the initially registered device as one of list entries in the storage portion 34A of the communication information list 34 (FIG. 4) (FIG. 7; S325).

<3> The group registration/generation unit 32 requests, of the group management unit 33, the registration of the group identifier and the initially registered device (FIG. 7; S326).

<4> If the registration of the initially registered device in addition to the group identifier is requested, the group management unit 33 references the communication information list 34 and extracts the information on the corresponding initially registered device.

<5> The group management unit 33 registers the information inputted to the group registration/generation unit 32 in the storage portion 31A of the ad hoc group information 31 (FIG. 8; S331 and S332). Specifically, the group identifier and the like specified by the operator are set to the group basic information and the group entry for which the information on the initially registered device has been set as one of the member entries is added to the group information 31.

<6> The group registration/generation unit 32 writes the group identifier in the group tag 1 (FIG. 7; S327). A required number of the group tags 1 are prepared and placed at desired positions.

[A-2. Registration of Communication Information]

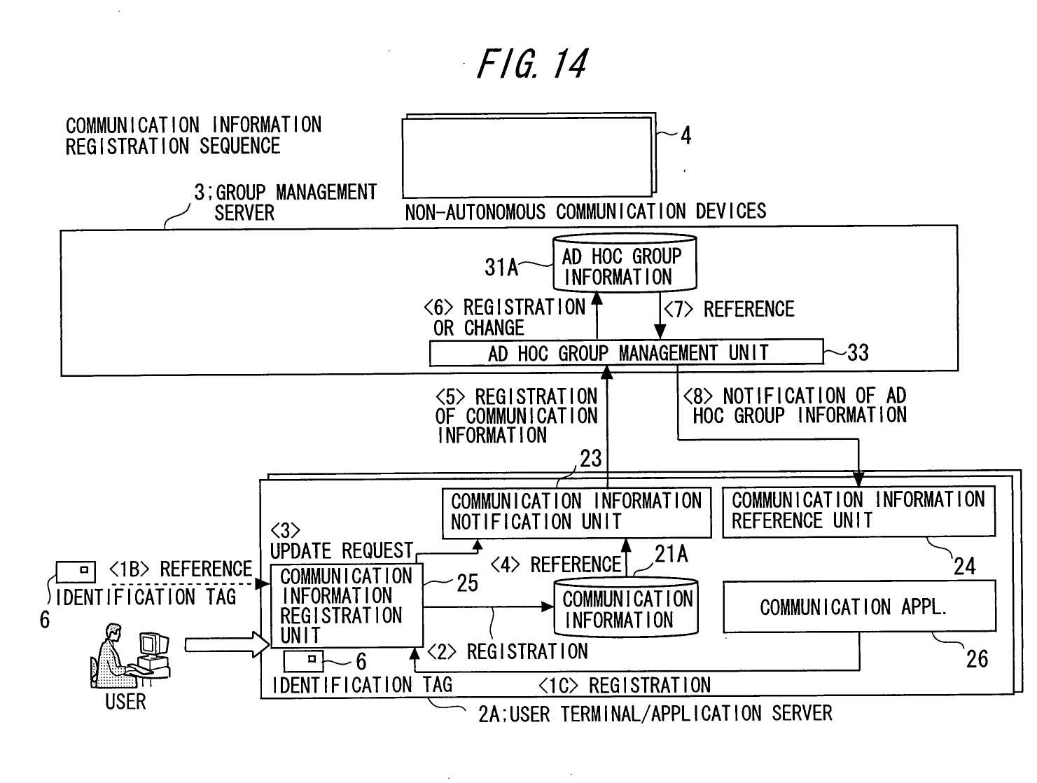

FIG. 14 shows an example of a communication information registration sequence. The sequence shown in FIG. 14 is as follows.

(1) Association of Person with Device

<1A> A user activates the communication information registration unit 25 of the user terminal (a PDA, PC, or the like) 2A and manually inputs the user information to the communication information registration unit 25 via an input device not shown (FIG. 12; S251, S252, and S253).

<1B> Alternatively, the user may also input the user information by activating the communication information registration unit 25 of the user terminal 2A and causing the communication information registration unit 25 to read the user information stored in the identification tag 6 such as an ID card (FIG. 12 ; S251, S252, and S257).

(2) Association with Application

<1C> The communication application 26 activated on the user terminal 2A or the application server 2B notifies the communication information registration unit 25 of the application information of its own (FIG. 6; S261, FIG. 12; S258).

<2> The communication information registration unit 25 registers the user information and the application information in the storage portion 21A of the communication information 21 (FIG. 5 and FIG. 12; S254 and S255). A user entry and an application entry are added.

<3> The communication information registration unit 25 issues an update request to the communication information notification unit 23 (FIG. 12; S256).

<4> The communication information notification unit 23 references the communication information stored in the storage portion 21A (FIG. 10; S231). In short, the communication information notification unit 23 reads the communication information from the storage portion 21A.

<5> The communication information notification unit 23 performs the registration of the communication information in the group management unit 33 of the group management server 3 (FIG. 10; S232 and S235). Specifically, the communication information registration unit 23 requests the update of the communication information of the group management unit 33 of the group management server 3 for managing the groups identified with the group identifiers in the notification list of the communication information.

<6> The group management unit 33 registers the communication information reported from the communication information notification unit 23 in the storage portion 31A (the corresponding group entry) of the group information 31 (FIG. 3 and FIG. 8; S335, S336, and S337). At this time, the communication information related to the update is registered as member entries in the group entry corresponding to the group identifier.

<7> The group management unit 33 references the reference list of the group information 31 (FIG. 8; S338).

<8> The group management unit 33 notifies the communication information reference unit 24 of each of the terminals having the terminal identifiers in the reference list of the updated group information (FIG. 8; S339).

[A-3. Group Registration]

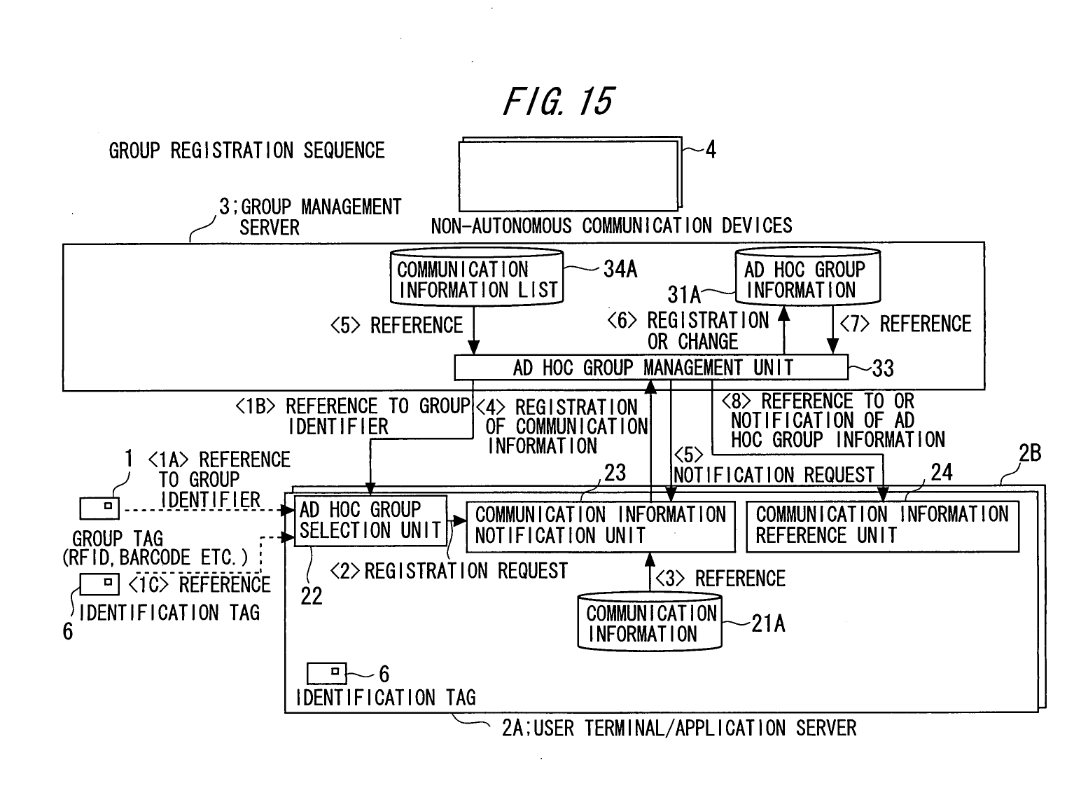

FIG. 15 is a view showing an example of a group registration sequence. The sequence shown in FIG. 15 is as follows. The user terminal 2A or the application server 2B (terminal) is assigned to a group by referencing the same group identifier imparted to show any significant information. As a method for associating the terminal with the group, there can be considered the following methods.

<1A: First Method> Recording the group identifier classified according to the significant information (such as a place) in the group tag 1(such as a barcode or an RFID) and assigning a device (terminal) which has read the group tag 1 to the group (FIG. 9; S221, S222, S223, and S224).

<1B: Second Method> Accessing an application (mounted on, e.g., the terminal) for specifying the group identifier from the device (terminal). The application displays, e.g., a directory (provided by, e.g., the group management server 3) of group identifiers classified according to the significant information and notifies the user to make a selection.

Alternatively, if the significant information is a place, the selection of the group identifier by the user is supported by notifying the user to choose automatic selection of the group identifier or displaying the current position by using means for specifying a position (specifying a place based on an IP address, specifying a position using a GPS (Global Positioning System), or specifying a position using the cell of a mobile phone) not mentioned in the present invention. Such an application may also be constructed to dynamically generate a group.

As a simple and easy method, there is one which prints the numerical code of the group identifier on the group tag 1 and manually inputs the numerical code. There is also a method which shows, in the group tag 1, a group name (such as Meeting Room A) displayed on the selection screen for a group identifier and notifies the user to select the group name (FIG. 9—S221, S222, S226, S227, and S228).

<1C: Third Method> An RFID reader (not shown) holding one of the group identifiers classified according to the significant information in the internal memory thereof reads the RFID tag (with the identification information for an external device recorded therein) provided in the external device and thereby associates the terminal (external device) with the group identifier (FIG. 9; S221, S222, S223, and S224).

<2> The group selection unit 22 notifies the communication information notification unit 23 of the group identifier referenced thereby (acquired through the first to third methods) (FIG. 9; S225).

<3> The communication information notification unit 23 references the storage portion 21A of the communication information 21 and reads information necessary for group registration (FIG. 10; S231).

<4> The communication information notification unit 23 requests, of the group management unit 33 of the group management server 3, the registration of the communication information for the group identifier (FIG. 10; S232, S233, and S234).

<5> The group management unit 33 references, if it cooperates with the external device in accordance with the third method described above, the communication information list 34 as required (FIG. 8; S335 and S336).

<6> The group management unit 33 performs the registration of the communication information in the storage portion 31A of the group information 31 (FIG. 8; S337). Specifically, the group management unit 33 registers communication information as member entries in the group entry corresponding to the group identifier.

<7> The group management unit 33 references the reference list of the group information 31 and recognizes terminal identifiers in the reference list (FIG. 8; S338).

<8> The group management unit 33 notifies the communication information reference unit 24 of each of the terminals having the terminal identifiers in the reference list of the updated group information (FIG. 8; S339).

<<B. Access to Group Constituent Member>>

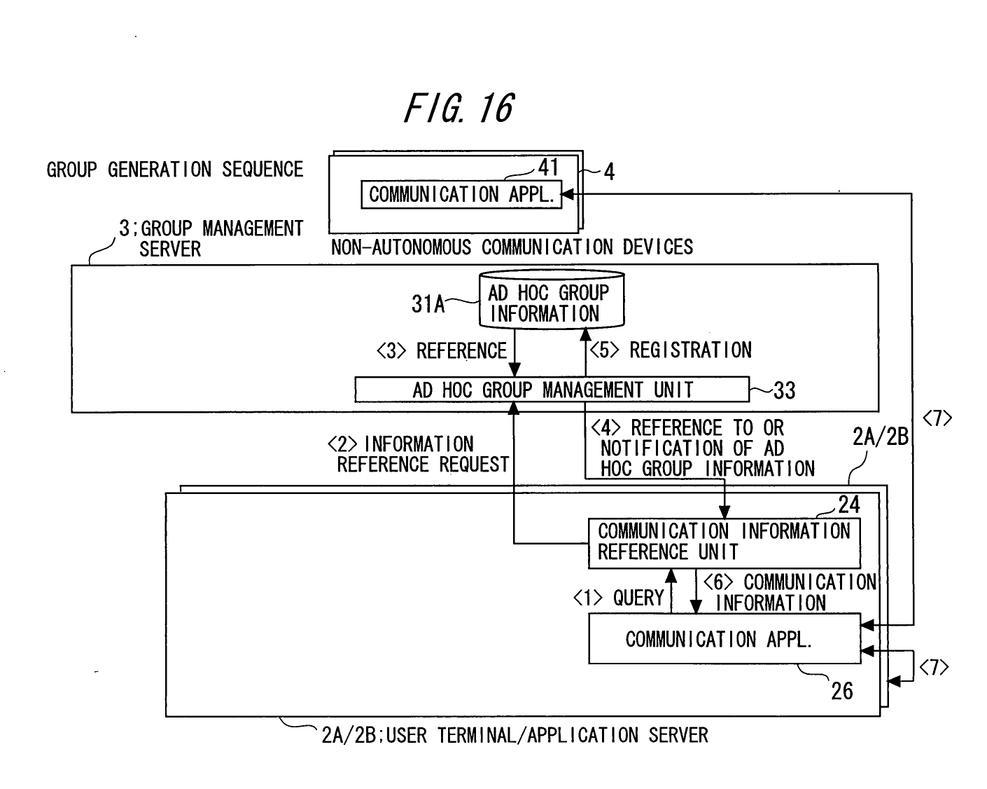

FIG. 16 shows an example of a group information reference sequence. The sequence shown in FIG. 16 is as follows.

<1> The communication application 26 of the user terminal 2A/application server 2B generates a query condition in accordance with the service to be provided and transmits a query to the communication information reference unit 24 (FIG. 6; S262 and S263).

<2> The communication information reference unit 24 sends an information reference request to the ad hoc group management unit 33 of the group management server 3 (FIG. 11; S241 and S242).

<3> The group management unit 33 extracts the specified information on the group (group entry) from the group information storage portion 31 (FIG. 8; S331 and S3310)

<4> The group management unit 33 notifies the communication information reference unit 24 of the information on the group (group entry) extracted from the group information storage portion 31 (FIG. 8; S3311).

<5> The identification information for the user terminal 2A or the application server 2B that has transmitted the information reference request is registered in the reference list of the group information 31 (FIG. 8; S3312).

<6> The communication information reference unit 24 compares the group information of which it has been notified with the query condition specified by the communication application 26 and reports, if they match, the information desired by the communication application 26 (FIG. 11; S243 and S244)

<7> The communication application 26 determines a communication target depending on the service to be provided, establishes a communication session with the communication target based on the application information of the group information, and provides a communication service (FIG. 6; S263, S264, and S265)

### APPLICATION EXAMPLES

The following is three examples of a service which is enabled by using the group generation/service provision system described above.

### Application Example 1

### Protection of Privacy from Monitor Camera

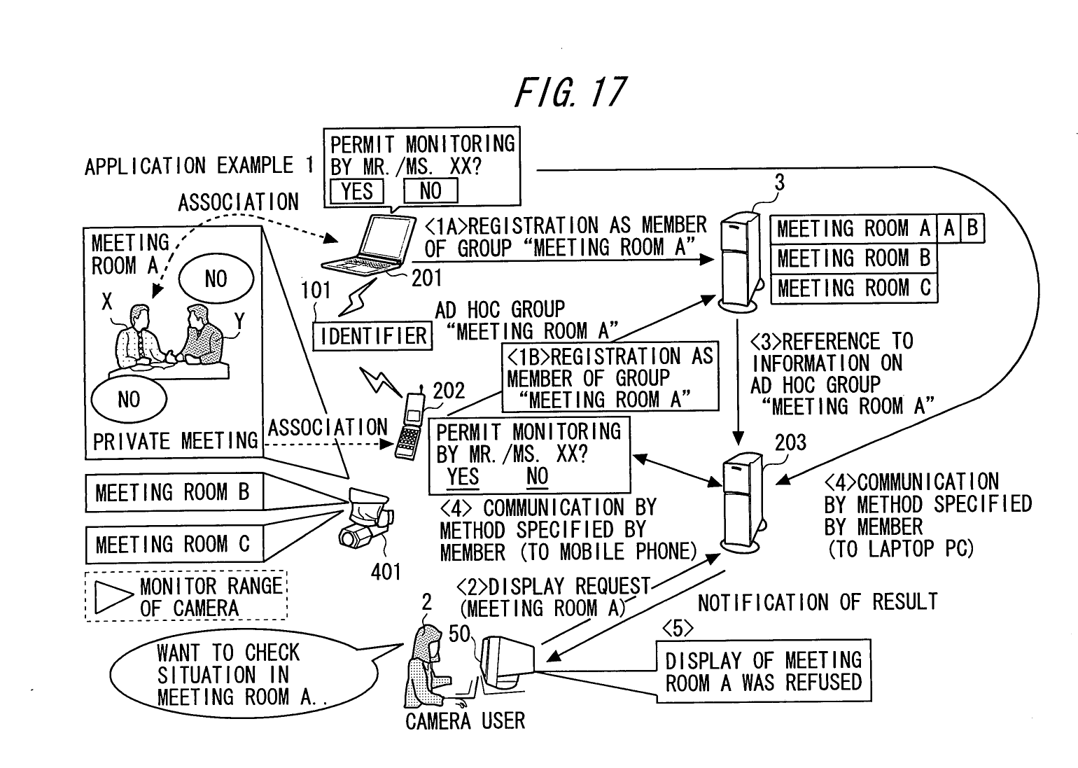

FIG. 17 shows the execution sequence of a privacy protection service against a monitor camera as Application Example 1.

[Outline of Service]

<1A> A note-type PC 201 associated with a user X reads the group identifier imparted to a meeting room A from the RFID tag 101 and executes member registration in the group “Meeting Room A” with respect to the group management server 3.

<1B> Likewise, a mobile phone 202 associated with a user Y reads the group identifier imparted to the meeting room A from the RFID tag 101 and executes member registration in the group “Meeting Room A” with respect to the group management server 3.

<2> A person (camera user) Z who wants to check a situation in the meeting room A with an image shot by a WEB camera 401 placed in the meeting room A operates a PC 50 for monitoring and gives a request to display the meeting room A to the application server 203 which controls the operation of the WEB camera 401.

<3> Prior to the control of the WEB camera 401, the application server 203 acquires the group information of the meeting room A from the group management server 3 and references it.

<4A, 4B> The application server 203 recognizes, based on the result of referencing the group information, the registration of the PC 201 of the user X and the mobile phone 202 of the user Y as the members of the group “Meeting Room A” and inquires of the members of the group whether or not display is permitted.

Specifically, the inquiry of whether or not display is permitted is reported by using specified communication means to each of the PC 201 and the mobile phone 202. In this example, a warning notification inquiring whether or not the camera user Z is permitted to monitor the meeting room A is reported from the application server 203 to each of the PC 201 and the mobile phone 202 and a confirmation screen (warning display) based on the warning notification is shown on the display of each of the terminals 201 and 202.

Each of the users X and Y inputs a response (Permission/Refusal) to the warning display by operating the PC 201 or the mobile phone 202. The response information is then sent from each of the PC 201 and the mobile phone 202 to the application server 203 for notification.

<5> The application server 203 references the response information from each of the PC 201 and the mobile phone 202. If the response from either one of the PC 201 and the mobile phone 202 is “Refusal”, the application server 203 halts the control of the WEB camera 401 and notifies the camera user Z (PC 50) of the refusal. For example, the refusal of monitoring is displayed on the display of the PC 50 for monitoring.

If the response information from each of the PC 201 and the mobile phone 202 is “Permission”, the application server 203 gives a control signal to the WEB camera 401. The WEB camera 401 shoots an image of the meeting room A based on the control signal. The shot image is given from the WEB camera 401 to the PC 50 for monitoring directly or via the application server 203. Consequently, the image showing the situation in the meeting room A is displayed on the display of the PC 50 for monitoring. In this case, it is also possible to notify the user Z (PC 50) of the permission of monitoring prior to the control of the WEB camera 401.

### DETAILED DESCRIPTION

In Application Example 1 shown in FIG. 17, each of the PC 201 and the mobile phone 202 corresponds to the user terminal 2A. The application server 203 of the WEB camera 401 corresponds to the application server 2B. The RFID tag 101 corresponds to the group tag 1. The WEB camera 401 corresponds to the non-autonomous communication device 4.

(1-1. Initial Setting)

In Application Example 1, the ad hoc groups have been associated with the meeting rooms. Specifically, the three ad hoc groups “Meeting Room A”, “Meeting Room B”, and “Meeting Room C” have been registered in the group management server 3 in accordance with the group generation method described above (see Section A-1). As an initially registered device, the WEB camera 401 capable of shooting an image of each of the meeting rooms A, B, and C has been registered in each of the ad hoc groups.

Information on the user X has been registered as the user information in the storage portion 21A of the communication information 21 of the PC 201 in accordance with the communication information registration method described above (see Section A-2) On the other hand, information on the user Y has been registered as the user information in the storage portion 21A of the communication information 21 of the mobile phone 202 in accordance with a similar communication information registration method.

In each of the PC 201 and the mobile phone 202, the communication application 26 for receiving the warning notification from the application server 203 which controls the WEB camera 401 has been installed and activated. The application information of the communication application 26 has been registered in each of the storage portions 21A in accordance with the communication information registration method described above (see Section A-2)

(1-2. Formation of Ad Hoc Group)

In the meeting room A, the RFID tag 101 has been placed and stored therein the group identifier indicative of the group “Meeting Room A”. When the users X and Y enter the meeting room A, the group identifier in the RFID tag 101 is read by the PC 201 and the mobile phone 202 therefrom. Each of the PC 201 and the mobile phone 202 has an RFID reader and is in the state in which a mode for registering ad hoc groups through the automatic reading of the group identifiers has been selected.

The PC 201 that has acquired the group identifier from the RFID tag 101 registers the communication information of the PC 201 as a member entry to the group “Meeting Room A” with respect to the group management unit 33 of the group management server 3 by using the group registration method described above (see Section A-3).

Specifically, the information on the PC 201 is registered as the terminal basic information, the information on the user X is registered as the user information, and information indicating a method for communication with the communication application 26 displaying the warning notification is registered as the application information, each in the member entry.

Upon acquisition of the group identifier from the RFID tag 101, the mobile phone 202 also registers the communication information of the mobile phone 202 as the member entry of the group “Meeting Room A” with respect to the group management unit 33 of the group management server 3.

[1-3. Reference to Ad Hoc Group Information]

The application server 203 of the WEB camera 401 presents a directory of the meeting rooms to the user, shoots an image of the meeting room selected by the user by using the WEB camera 401, and provides a service to be provided to the user. However, the application server 203 does not perform the shooting in this service if there is a person in the meeting room and a shooting permission is not obtainable from the person in the meeting room before the shooting is started. Thus, the application server 203 has the function of protecting the privacy of a person to be shot.

To provide the privacy protecting function, a WEB camera application (corresponding to the communication application 26) on the application server 23 providing such a service references the information on the ad hoc groups associated with the meeting rooms from the group management server 3.

The application server 203 constantly monitors the group information of the groups “Meeting Room A”, “Meeting Room B”, and “Meeting Room C” from the group management server 3 in accordance with the method already described (see Section B).

When the camera user selects the meeting room A via a meeting room selection screen provided by the application server 203 to the user, the WEB camera application references the user information of each of the member entries and searches therein to check whether or not a person has been associated with the ad hoc group from the group management server 3.

In this case, the WEB camera application recognizes the registration of the users X and Y as members since the member entries including the user information are included in the group information (the group entry of the meeting room A) obtained as a result of searching from the group management server 3.

Then, the WEB camera application extracts the application information of each of the PC 201 and the mobile phone 202 corresponding to the users X and Y and requests the display of a warning of a warning notification application that has been activated on each of the PC 201 and the mobile phone 202 by using an access method specified by the application information. [0112]

In Application Example 1, it is assumed that the users X and Y have selected the refusal of monitoring in response to the display of a warning since they are holding a private meeting. Since the users X and Y have refused an access thereto, the WEB camera application notifies the camera user Z of the refusal of the access. If the access is not refused, the WEB camera application references the application information for accessing the communication application 41 of the WEB camera 401 in the member entry of the WEB camera 401 and uses the WEB camera 401 to shoot the meeting room A.

In Application Example 1, the user to be monitored is allowed to determine about the accessibility. On the other hand, it is also possible to configure the WEB camera application such that it references the communication policy of the user information set to the communication information and the use policy of the application policy and the accessibility is determined automatically.

### Application Example 2

### Meeting Support Application

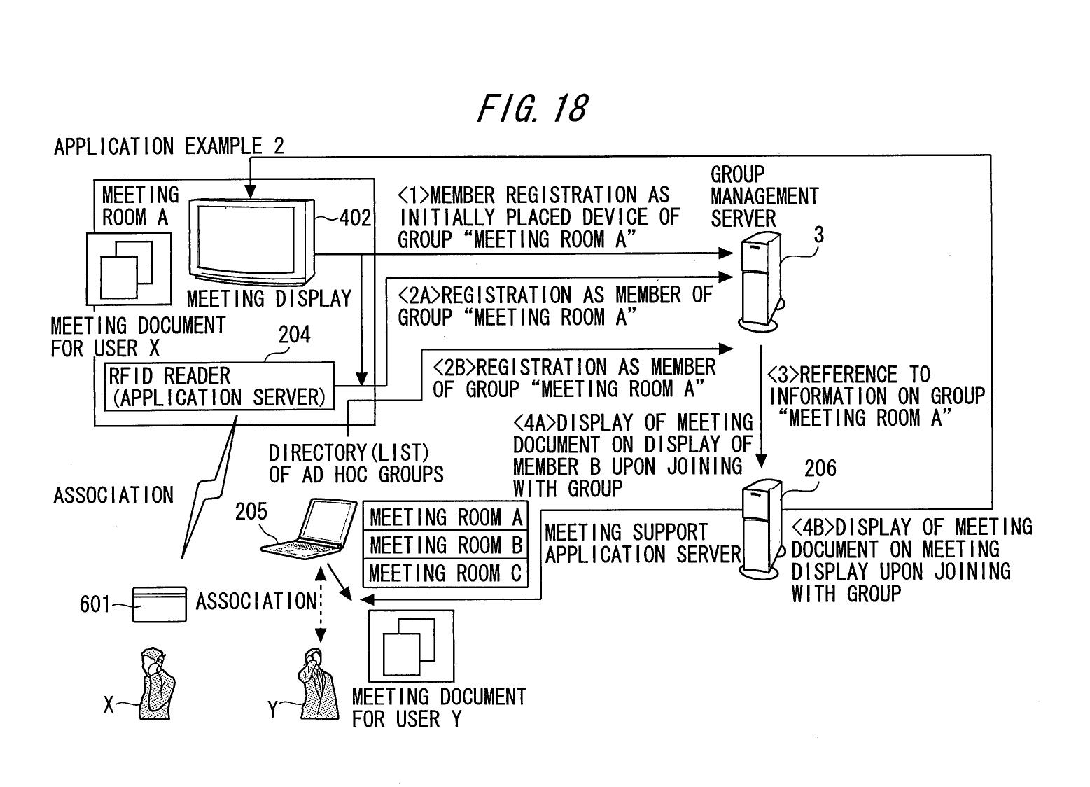

FIG. 18 shows the execution sequence of a meeting support application as Application Example 2.

[Outline of Service]

<1> The member registration of a meeting display 402 and an RFID reader 204 placed in the meeting room A as the initially registered devices of the group “Meeting Room A” is performed with respect to the group management server 3.

<2A> The user X using the meeting room A causes the RFID reader 204 placed in the meeting room A to read an ID card (with the information on the user X recorded therein) 601 of his own. Upon acquisition of the user information of the user X from the ID card 601, the RFID reader 204 transmits the user information to the group management server 3 together with the group identifier of the group “Meeting Room A” preliminarily stored in the internal memory thereof, whereby the registration of the user X as a member of the group “Meeting Room A” is performed with respect to the group management server 3.

<2B> The user Y using the meeting room A accesses the group management server 3 by using a PC 205 of his own and selects the meeting room A from the directory of ad hoc groups provided by the group management server 3 and thereby performs the registration as a member of the group “Meeting Room A”.

<3> A meeting support application server 206 for supporting a meeting using the meeting room A constantly monitors the registration as a member of the group “meeting room A” relative to the group management server 3.

<4> When the meeting support application server 206 senses a member change in monitoring the member registration, it displays a meeting document on a proper device.

### DETAILED DESCRIPTION

Each of the RFID reader 204 and the PC 205 shown in FIG. 18 corresponds to the user terminal 2A. The meeting support application server 206 corresponds to the application server 2B. The meeting display 402 corresponds to the non-autonomous communication device 4. The ID card 601 possessed by the user X corresponds to the identification tag 6 of the user.

(2-1. Initial Setting)

In Application Example 2, groups have been associated with meeting rooms. As specific examples, three groups “Meeting Room A”, “Meeting Room B”, and “Meeting Room C” have been registered in the group management server 3 by an operator of a service by using the group generation method described above (see Section A-1). It is assumed that, at this time, the meeting display 402 has been registered in the meeting room A as an initially registered device. The RFID reader 204 is autonomously registered as a member of the group “Meeting Room A”.

In the PC 205, the information on the user Y has been set as the user information to the storage portion 21A of the communication information 21 in accordance with the communication information registration method described above (see Section A-2).

On each of the meeting display 402 and the PC 205, the communication application 26 for displaying the meeting document sent from the meeting support application server 206 for notification has been installed and activated and the application information of the communication application 26 has been set to the communication information 21 by using the communication information registration method described above (see Section A-2).

The RFID reader 204 has the group identifier of the group “Meeting room A” recorded in the internal memory thereof.

(2-2. Formation of Ad Hoc Group)

In Application Example 2, the RFID reader 204 is placed in the meeting room A in place of the group tag 1 and a member of the group “Meeting Room A” is registered by the RFID reader 204 through the reading of the identification information recorded in the identification tag 6 of the user.

On entering the meeting room A, the user X causes the RFID reader 204 placed in the meeting room A to read the ID card 601 of the user X. The RFID reader 204 then adds the user information read from the ID card 601 to the communication information 21 in accordance with the communication information registration method described above (see Section A-2).

The RFID reader 204 further notifies the group management server 3 of a request to update the communication information and thereby notifies the group management server 3 of a change in the communication information (addition of the user X).

On the other hand, the user Y references, on entering the meeting room A, the directory of ad hoc groups provided by the group management server 3 by using the PC 205 through the manual selection described above (see Section A-2), selects the group “Meeting Room A” from the directory of groups, and notifies the group management server of the member registration request from the PC 205.

At this time, the user Y can register the member entry of the PC 205 with respect to the group management server 3 by causing the RFID reader 204 to read the identification tag 6 (not shown) of the PC 205 (using means for registering an external member), instead of implementing the group selection method described above.

That is, the RFID reader 204 generates, upon reading the information on the PC 205 from the identification tag 6, the communication information related to the PC 205 and requests the registration of the PC 205 as a member of the group “Meeting Room A” of the group management server 3.

(2-3. Reference to Ad Hoc Group Information)

The meeting support application server 206 monitors a change in the meeting room ad hoc group (a change in the members of the group “Meeting Room A”) and provides, to a person who has entered the meeting room A (the user who has joined the group “Meeting Room A”), the service of displaying a reservation screen for the meeting rooms and the meeting document (preliminarily held) on a proper device. The meeting support application server 206 has a meeting support application as the communication application 26 for providing the service described above.

The meeting support application server 206 constantly monitors the group information of the group “Meeting Room A” via the group management server 3 in accordance with the method for accessing the group constituent member described above (see Section B).

Upon sensing a change in the group “Meeting Room A”, the meeting support application compares the user information of each of the member entries with an information transmission list (a list specifying the destinations of information (such as the meeting document) to be transmitted to member users) managed by the meeting support application If it finds a user to whom the information has not been transmitted, the meeting support application selects a proper display device and displays the information thereon.

Upon receipt of the notification that the user information of the user X has been added from the RFID reader 204, the meeting support application references the application information or terminal basic information of the RFID reader 204. In Application Example 2, the RFID reader 204 does not have a display and the communication application for displaying the meeting document has not been activated, either. Accordingly, the RFID reader 204 cannot display the information.

On recognizing that the RFID reader 204 cannot display the information as a result of referencing the application information or terminal basic information of the RFID reader 204, the meeting support application determines an alternative device from among the member entries.

In a method of specifying an alternative device, information indicative of alternative devices is defined in, e.g., the communication policy of the user entry that has been set to the communication information, the use policy of the application entry, or the terminal basic information, and an alternative device can be specified by referencing the alternative device information.

In this example, the use of the meeting display 402 as the alternative device for displaying the information is included in the terminal basic information of the RFID reader 204, and the meeting support application recognizes that the meeting display 402 has been selected as an alternative device by referencing the terminal basic information. However, the method of specifying an alternative device does not necessarily require the use of the user entry and another method may also be used.

The meeting support application transmits the meeting document for the user X to the communication application 41 for displaying the meeting document possessed by the meeting display 402 in accordance with a method specified in the application entry of the meeting display 402.

When the communication information of the PC 205 has been registered, the meeting support application references the application information (application entry) or terminal basic information of the PC 205. In Application Example 2, the PC 205 has a display and the communication application for displaying the meeting document has been activated. The terminal basic information or application information of the PC 205 includes such information.

Accordingly, the meeting support application selects the PC 205 as a device for displaying the meeting document to the user Y. The meeting support application transmits the meeting document to the communication application 26 for displaying the meeting document on the meeting display 402 in accordance with a method specified by the application information of the PC 205.

### Application Example 3

### Video Phone Application

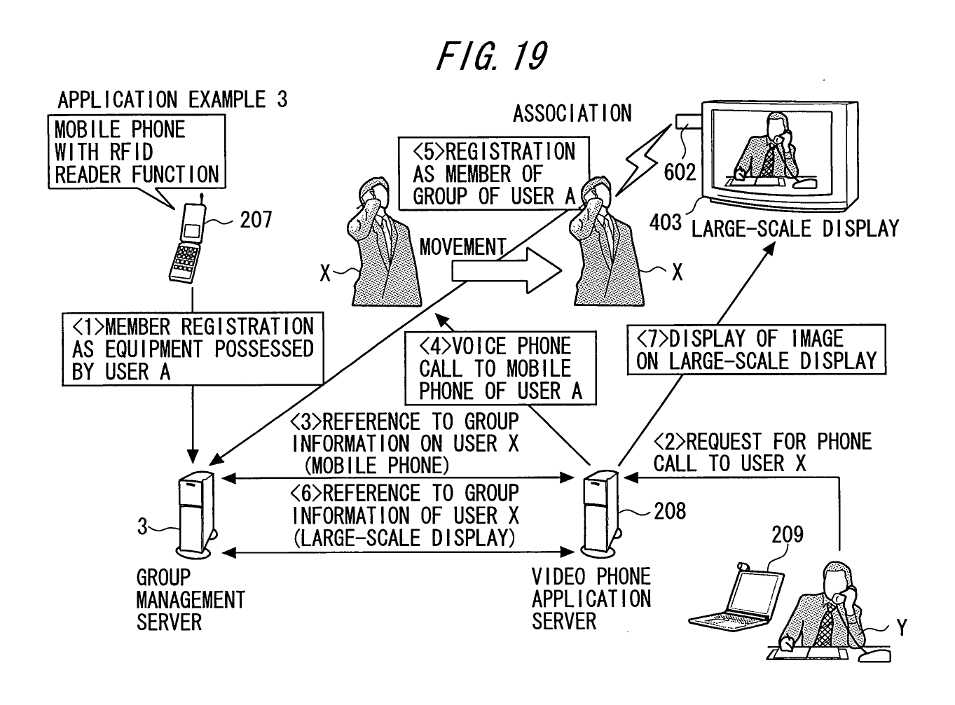

FIG. 19 shows the execution sequence of a video phone application as Application Example 3.

[Outline of Service]

<1> A mobile phone 207 possessed by the user X is registered as a member of the ad hoc group “User X” with respect to the group management server 3.

<2> The user Y requests a phone call to the user X of a video phone application server 208.

<3> The video phone application server 208 references the group information of the group “User X” managed at the group management server 3 and recognizes that only the mobile phone 207 can be used for a phone call to the user X.

<4> The video phone application server 208 sets a phone call path to the user Y for the mobile phone 207 of the user X.

<5> When the mobile phone 207 of the user X approaches a large-scale display 403 as a result of the movement of the user X, large-scale display 403 is registered as a member of the group “User X” with respect to the group management server 3. The member registration is performed by an RFID reader mounted on the mobile phone 207 through the reading of information (including the communication information) on the large-scale display 403 from an identification tag (RFID tag) 602 disposed in the vicinity of the large-scale display 403 and the notification of the information on the large-scale display 403 together with the group identifier “User X” to the group management server 3.

<6> The video phone application server 208 periodically references the group information of the group “User X” managed at the group management server 3. This allows the video phone application server 208 to sense the addition of the large-scale display 403 as a device usable for a phone call to the user X.

<7> The video phone application server 208 sets an image path to the user Y for the large-scale display 403, while sustaining the phone call to the mobile phone 207.

### DETAILED DESCRIPTION

In Application Example 3, the mobile phone 207 corresponds to the user terminal 2A. The video phone application server 208 corresponds to the application server 2B. The large-scale display 403 corresponds to the non-autonomous communication device 4. The identification tag 602 provided in the large-scale display 403 corresponds to the identification tag 6.

(3-1. Initial Setting)

In Application Example 3, a group has been associated with a user. Specifically, the ad hoc group “User X” has been generated in accordance with the group generation method described above (see Section A-1) and registered in the group management server 3.

The mobile phone 207 includes means (which is herein the RFID reader) for reading the identification tag 6 so that an external device such as the large-scale display 403 is registered as a member of the group “User X”.

In the mobile phone 207, information on a user A has been set as the user information to the communication information 21 by using the communication information registration method described above (see Section A-2).

On each of the large-scale display 403 and the mobile phone 207, the communication application 26 for holding a TV meeting has been installed and activated, and the application information has been set to the communication information 21 in accordance with the communication information registration method described above (see Section A-2).

The mobile phone 207 has the group identifier of the group “User X” recorded therein and notifies, on reading the information on an external device by using the RFID reader, the group management server 3 of the information on the external device together with the group identifier.

(3-2. Formation of Ad Hoc Group)

Application Example 3 shows an example of a service when the categorization of devices around a user is performed as another example of significant information for distinguishing a group.

Upon the turning ON of its power source, the mobile phone 207 autonomously requests, of the group management server 3, the registration of the mobile phone 207 as a member of the group “User X” in accordance with the group registration method described above (see Section A-3). The group management server 3 registers the communication information of the mobile phone 207 as a member entry in the group entry of the group “User X”.

When the user X operates the mobile phone 207 and the RFID reader of the mobile phone 207 reads the information on the large-scale display 403 from the identification tag 602 of the large-scale display 403, the mobile phone 207 registers the member entry of the large-scale display 403 in the group information of the group “User X” managed at the group management server 3 by using means for registering an external device as a member.

Specifically, when a request for member registration (the communication information registration request) including the information on the large-scale display 403 is reported from the mobile phone 207 to the group management unit 33 of the group management server 3, the group management unit 33 extracts, from the communication information list 34, the communication information of the large-scale display 403 (preliminarily registered as a non-autonomous communication device) and registers it in the member entry of the group “User X”.

Alternatively, the mobile phone 207 may also read the information on the large-scale display 403 including the communication information from the identification tag 602 and notify the group management unit 33 of a request to register the communication information such that the group management unit 33 registers the communication information obtained from the mobile phone 207 in the member entry of the group “User X”.

(3-3. Reference to Ad Hoc Group Information)

The video phone application server 208 individually controls a voice path and the image path and provides, to the user, the service of coordinating the meeting by selecting a proper device for each of the voice path and the image path. The server 208 has the communication application 26 (TV meeting application) for providing such a service.

The video phone application server 208 constantly monitors the group information of the group “User X” via the group management server 3 by using the method for referencing the group constituent member described above (see Section B).

On sensing a change in the group “User X”, the TV meeting application compares the member information of the group “User X” with path setting information managed by the TV meeting application, selects an optimum device for each of the paths, and thereby setting a communication path.

It is assumed herein that the user Y has requested a phone call to the user X from a laptop PC 209 with a camera by using the TV meeting application server 208 before the user X adds the large-scale display 403 to the members.

Then, the TV meeting application references the current member entries of the group “User X”managed at the group management server 3 and recognizes that the current member is only the mobile phone 207 and, judging from the terminal performance of the terminal basic information or the like, the mobile phone 207 is capable of only a voice phone call. Accordingly, the TV meeting application sets only the voice path between the mobile phone 207 of the user X and the laptop PC 209 of the user Y.

When the user X adds the large-scale display 403 to the members of the group “User X” thereafter, the TV meeting application senses a change in the group information of the group “User X” and further recognizes the member registration of the large-scale display 403 as a new device. Based on the recognition, the TV meeting application compares information on the newly registered member with the current path setting information.

The large-scale display 403 is capable of displaying an image. On the other hand, the path currently set between the users X and Y is only for voice. Accordingly, the TV meeting application sets the image path between the large-scale display 403 and the laptop PC 209 of the user Y.

As a result, the image of the user Y shot by using the camera of the laptop PC 209 is transmitted to the large-scale display 403 through the image path and displayed on the large-scale display by the communication application 41 possessed by the large-scale display 403. This allows the user X to make a phone call while viewing the user Y.

Application Example 3 may also be modified as follows. When the user X adds the large-scale display 403 to the members, the TV meeting application server 208 specifies a WEB camera capable of shooting the vicinity of the position at which the large-scale display 403 is placed and displays the image of the user X on the laptop PC 209 of the user Y by using the image path.

To implement such a function, it can be considered that, e.g., (1) the WEB camera is member registered as an initially registered device in the group “User x”, (2) the mobile phone 207 reads the identification tag 6 of the WEB camera placed as the non-autonomous communication device 4 and performs member registration, or (3) the TV meeting application is equipped with a specific WEB camera control function.

### EFFECTS OF EMBODIMENTS

With the system according to the embodiments, it becomes possible to realize flexible group management which does not limit the range of grouping to a communication target through the introduction of the group management server 3. This enables the use of a device not directly associated with the communication target.

With the system according to the embodiments, the registration as a member of an ad hoc group is implemented by referencing or selecting an identifier imparted to the ad hoc group. This enables the grouping not limited to a range reachable by a radio signal shown in the problem (2) and also implements grouping which does not limit a member to a device having a communication function.

1. A method for supporting service provision by using a computer, the method including:
receiving a request for member registration to an ad hoc group related to provision of a service and performing a process of the member registration;
managing ad hoc group information including communication information inclusive of information indicating a method for communication with each of members registered in the ad hoc group; and
providing the communication information to a provider of the service.

2. A method for supporting service provision according to claim 1, wherein the computer receives, from a device for reading identification information for an ad hoc group recorded on a recording medium placed at a specified position and not having means for communication with the computer, the request for the member registration of the device to the ad hoc group identified with the identification information read from the recording medium.

3. A method for supporting service provision according to claim 1, wherein the computer receives, from a device to be registered as the member of the ad hoc group, the request for the member registration of the device to the ad hoc group selected in the device.

4. A method for supporting service provision according to claim 1, wherein the computer receives the request for the member registration of an external device to the ad hoc group identified with identification information, the identification information is transmitted from a device having the identification information when the device detects the external device existing outside of the device.

5. An ad hoc group management server comprising:
a storage unit storing ad hoc group information including communication information inclusive of information indicating a method for communication with each of members registered in an ad hoc group related to provision of a service;
a management unit receiving, from a user terminal, a request for member registration of a device to be registered as the member of the ad hoc group and performing a process of the member registration with respect to the group information; and
a group information provision unit for providing the communication information included in the ad hoc group information to a provider of the service.

6. The ad hoc group management server according to claim 5, wherein the group information provision unit provides, every time the communication information included in the ad hoc group information is updated, the updated communication information to the provider of the service.

7. A terminal device including:
a selection unit selecting an ad hoc group related to provision of a service;
a notification unit notifying, of a member registration request for registering the terminal device or an external device existing outside thereof in the ad hoc group selected in the selection unit, a group management server for managing ad hoc group information including communication information inclusive of information indicating a method for communication with each of members registered in the ad hoc group; and
a processing unit referencing, when the terminal device has been registered in the ad hoc group, the ad hoc group information managed at the group management server and receiving and processing information related to the service from an application server for providing the service by using the communication information included in the ad hoc group information.

8. The terminal device according to claim 7, wherein the selection unit reads identification information for an ad hoc group recorded in a recording medium placed at a specified position and not having means for communication with the group management server and selects the ad hoc group identified with the identification information.

9. The terminal device according to Note 7, wherein the selection unit shows a list of ad hoc groups to a user and selects, from the list, one of the ad hoc groups specified by the user.

10. The terminal device according to claim 7, wherein the selection unit includes:
a storage region storing therein identification information for the ad hoc group; and
a sensor sensing an external device existing outside of the terminal device, and
wherein the selection unit selects the ad hoc group identified with the identification information stored in the storage region when the sensor senses the external device.

11. The terminal device according to Note 7, further comprising a communication information storage unit storing therein the communication information for performing communication with the processing unit,
wherein the notification unit notifies the group management server of a user registration request including the communication information stored in the communication information storage unit, and
wherein the notification unit references a list of ad hoc groups each joined by the terminal device as the member thereof when the communication information stored in the communication information storage unit is updated and notifies the group management server managing the ad hoc groups in the list of a request to update the communication information.

12. An application server comprising:
a reference processing unit referencing communication information inclusive of information indicating a method for communication with each of members registered in an ad hoc group related to provision of a service and managed at a group management server; and
a communication processing unit performing communication related to the provision of the service with each of the members by using the communication information.

13. A system for supporting service provision, the system comprising:
a group management server managing ad hoc group information including communication information inclusive of information indicating a method for communication with each of members registered in an ad hoc group related to provision of a service;
a first terminal notifying the group management server of a member registration request for registering the first terminal or an external device existing outside thereof in the ad hoc group; and
a second terminal for referencing the ad hoc group information managed at the group management server and performing communication related to the provision of the service with each of the members of the ad hoc group by using the communication information included in the ad hoc group information.

14. The system for supporting service provision according to claim 13, wherein the ad hoc group management server includes:
an ad hoc group registration/generation unit generating the ad hoc group;
an ad hoc group management unit managing the ad hoc group; and
an ad hoc group information storage unit storing therein information on the ad hoc group.

15. The system for supporting service provision according to claim 14, wherein the ad hoc group management server includes a communication information list for extracting the communication information of a device registered as the member of the ad hoc group.

16. The system for supporting service provision according to claim 14, wherein the ad hoc group registration/generation unit outputs identification information for the generated ad hoc group to a recording medium placed at a specified position and used when a device registered as the member performs member registration.

17. The system for supporting service provision according to claim 13, wherein the first terminal includes:
a communication application operating on the first terminal to execute a communication service;
a communication information storage unit storing therein the communication information inclusive of information indicating a method for communication with the communication application;.
an ad hoc group selection unit selecting the ad hoc group to be joined by the first terminal or the external device existing outside thereof as the member thereof; and
a communication information notification unit notifying, when the first terminal joins the ad hoc group as the member thereof, the ad hoc group management server of the member registration request including the communication information stored in the communication information storage unit.

18. The system for supporting service provision according to claim 13, wherein the second terminal references the communication information related to a member of the group desired by the ad hoc group management server.

19. The system for supporting service provision according to claim 17, wherein
the ad hoc group management server has a reference list indicative of a list of second terminals each referencing the ad hoc group information,
the first terminal has a notification list indicative of a list of ad hoc groups in each of which the first terminal has been registered,
the communication information notification unit of the first terminal references the notification list when the communication information stored in the communication information storage unit is updated and requests, of the group management server, the update of the communication information included in the ad hoc group information of the ad hoc groups in the notification list, and
the ad hoc group management unit of the group management server references the reference list when the communication information is updated in response to the update request and notifies the second terminals in the reference list of the update of the communication information.
